(19) United States
(12) Patent Application Publication
(10) Pub. No.: US 2011/0134105 A1
(43) Pub. Date: Jun. 9, 2011

(54) METHOD OF DRIVING PLASMA DISPLAY PANEL, AND PLASMA DISPLAY APPARATUS

(76) Inventors: Hideki Nakata, Osaka (JP); Hiroyasu Makino, Osaka (JP); Yasuhiro Arai, Osaka (JP); Toshikazu Wakabayashi, Osaka (JP); Satoshi Kominami, Osaka (JP); Masumi Izuchi, Osaka (JP); Junko Matsushita, Osaka (JP)

(21) Appl. No.: 13/058,414

(22) PCT Filed: Jun. 15, 2010
(86) PCT No.: PCT/JP2010/003957

§ 371 Date: Feb. 10, 2011

(30) Foreign Application Priority Data
Jul. 3, 2009 (JP) 2009158909

(51) Int. Cl. G09G 3/28; G06F 3/038

(52) U.S. Cl. 345/212; 345/41

(57) ABSTRACT

In a driving method of a plasma display panel of the present invention, plural display electrode pairs are divided into plural display electrode pair groups and one field is divided into plural sub-fields. The length of the sustain period is compared to the length of the erase period. If the sustain period is longer than the erase period, sustain discharge and erase discharge are performed for each of the display electrode pair groups, while if the sustain period is shorter than the erase period, sustain discharge and erase discharge of one display electrode pair group are synchronized with those of another display electrode pair group. For a sub-field with a largest luminance weight or a sub-field with a highest lighting ratio, sustain discharge and erase discharge of one display electrode pair group are synchronized with those of another display electrode pair group without fail.

### TECHNICAL FIELD

The present invention relates to a method of driving a plasma display panel, and a plasma display apparatus using the driving method.

### BACKGROUND ART

AC surface discharge type panels, which are typical plasma display panels, has a structure in which a number of discharge cells are formed between a front substrate and a back substrate which are placed so as to face each other.

On the front substrate, plural display electrode pairs each including a scan electrode and a sustain electrode are formed so as to extend in parallel with each other. On the back substrate, plural data electrodes are formed so as to extend in parallel with each other. The front substrate and the back substrate are disposed opposite to each other such that the display electrode pairs three-dimensionally cross the data electrodes, and sealed. A discharge gas is filled into an inner discharge space. The discharge cells are formed at portions where the display electrode pairs are opposite to the data electrodes.

In a driving method of the plasma display panel, a sub-field method is used, in which one field is divided into plural sub-fields and gray scale display is performed using a combination of sub-fields for emitting light. Each sub-field includes a reset period, a write (address) period, and a sustain period. During the reset period, reset discharge is generated, forming wall charge necessary for a next write operation. During the write period, write discharge is selectively generated in discharge cells based on an image to be displayed, forming wall charge. During the sustain period, a sustain voltage pulse is applied alternately to the display electrode pairs to generate sustain discharge, and phosphor layers of the associated discharge cells are caused to emit light. Thus, the image is displayed.

In the sub-field method, an ADS (address and display separation) method is commonly used, in which the write period and the sustain period are separated in time from each other so as not to overlap with each other, by conforming phases of sustain periods of all of discharge cells. In the ADS method, there are no timings when discharge cells generating write discharge and discharge cells generating sustain discharge coexist. Therefore, the plasma display panel is driven under an optimal condition for the write discharge in the write period and under an optimal condition for the sustain discharge in the sustain period. For this reason, discharge control is relatively easy and a driving margin of the plasma display panel can be set to a large one.

On the other hand, in the ADS method, since the sustain period must be set in a period except for the write period, sufficient sub-fields for improving an image display quality cannot be ensured in number if a time required for the write period increases because of higher definition of the plasma display panel, etc.

To solve such a problem, a driving method, in which display electrode pairs are divided into plural groups, and start times of the sub-fields in respective groups are shifted so that write periods of two or more groups, among the plural groups, do not overlap with each other in time, and a plasma display apparatus using the driving method (e.g., see patent literature 1, and the like), are proposed. Patent literature 1 discloses the plasma display apparatus, in which a scan electrode driving circuit for driving scan electrodes and a sustain electrode driving circuit for driving sustain electrodes are independently provided for each of the groups into which the display electrode pairs are divided, and the respective groups are driven at different timings (see patent literature 1 (page 4-5, FIG. 2)).

### CITATION LIST

### Patent Literature

Patent literature 1: Japanese Laid-Open Patent Application Publication No. 2005-157338

### SUMMARY OF THE INVENTION

### Solution to Problem

In a case where the plasma display apparatus disclosed in Patent literature 1 is used to ensure a sufficient sub-field number to improve a display quality of the plasma display panel, it is necessary to drive the plural display electrode pair groups into which the plural display electrode pairs are divided, at timings different from each other. There is a need to provide scan electrode driving circuits and sustain electrode driving circuits which are as many as the plural display electrode pair groups.

However, if the plasma display panel is driven using the plural scan electrode driving circuits and the plural sustain electrode driving circuits, a luminance difference is generated in the vicinity of a display region which is a boundary between the display electrode pair groups. This results in a degraded display quality of the plasma display panel.

Such a luminance difference arises from a difference in load in sustain discharge between the display electrode pair groups. To be specific, the number of discharge cells which light is different between the display electrode pair groups depending on a display image, and therefore, a discharge electric power required for the sustain discharge is different between the display electrode pair groups. In particular, the voltage applied to respective discharge cells is different because of an influence of an impedance of a sustain pulse generating circuit.

As a result, a discharge intensity of the discharge cells is different between the display electrode pair groups, and therefore a luminance difference is generated in the vicinity of a display region which is a boundary between the display electrode pair groups. Furthermore, if the luminance difference is increased if a performance difference between the plural scan electrode driving circuits and a performance difference between the plural sustain electrode driving circuits, are significant.

The present invention has been made to solve the above described problem, and an object of the present invention is to provide a driving method of a plasma display panel in which a sufficient sub-field number is ensured even in a high-definition plasma display panel, and a luminance difference is less likely to be generated in the vicinity of a display region which is a boundary between the display electrode pair groups, and a plasma display apparatus using the driving method.

### Solution to Problem

To achieve the above objective, there is provided a method of driving a plasma display panel including plural display electrode pairs each including a scan electrode and a sustain electrode, and plural data electrodes, and having a structure in which discharge cells are respectively formed at locations where the display electrode pairs cross the data electrodes, respectively, in which each field constituting an image includes plural sub-fields; each of the sub-fields includes a write period during which the discharge cells generate write discharge, a sustain period during which the discharge cells which generated write discharge generate sustain discharge, and a wall voltage adjusting period during which wall voltage of the discharge cells which generated the sustain discharge is adjusted for next write discharge, the method comprising: comparing the sustain period to the wall voltage adjusting period, in each of the sub-fields; selecting a first driving mode in which the plural display electrode pairs are divided into plural display electrode pair groups, the sustain period and the wall voltage adjusting period are set for each of the display electrode pair groups, and in a period in which one display electrode pair group is in the wall voltage adjusting period, successive write operation in display electrode pair groups other than the one display electrode pair group is restricted, if the sustain period is longer than the wall voltage adjusting period; or selecting a second driving mode in which the sustain period and the wall voltage adjusting period are performed for all of the display electrode pairs in the plasma display panel, if the sustain period is shorter than the wall voltage adjusting period.

In the first driving mode, the sustain period and the wall voltage adjusting period are set at different timings between the plural display electrode pair groups. In the first driving mode, successive write address operation is performed for all of the display electrode pair groups in periods other than the wall voltage adjusting periods of all of the display electrode pair groups, while in a wall voltage adjusting period of a certain display electrode pair group, a successive write operation for the remaining display electrode pair groups is restricted. Therefore, the write period and the sustain period can be set in a certain sub-field so that after a write operation for one display electrode pair group terminates, the following write operation for another display electrode pair group occurs, and the sustain discharge is performed. Thus, an overall driving time can be reduced.

On the other hand, in a case where the sustain period is shorter than the wall voltage adjusting period, a write operation is restricted when any one of the display electrode pair groups is in the wall voltage adjusting period, and a driving time increases because of a time corresponding to the restricted write operation. In this case, it is possible to further reduce an overall driving time by setting the second driving mode for setting the sustain period and the wall voltage adjusting period such that the sustain period and the wall voltage adjusting period of one display electrode pair group are synchronized with the sustain period and the erase period of another display electrode pair groups, in all of the display electrode pair groups.

To this end, the length of the sustain period is compared to the length of the wall voltage adjusting period, and the first driving mode is selected if the sustain period is longer than the wall voltage adjusting period, while the second driving mode is selected if the sustain period is shorter than the wall voltage adjusting period. This makes it possible to effectively reduce an overall driving time as compared to a case where the first driving mode or the second driving mode is fixed for all sub-fields like the conventional ADS method. Because of the reduction of the overall driving time, it is possible to easily ensure a sufficient sub-field number even in a high-definition plasma display panel.

There may be sub-fields in which the second driving mode is selected, among the plural sub-fields, as compared to a case where the first driving mode or the second driving mode is fixed for all sub-fields like the conventional ADS method. Regarding the sub-fields for which the second driving mode is selected, voltages applied to discharge cells are made uniform between the plural display electrode pair groups, and thus, it is possible to suppress generation of a luminance difference in the vicinity of a display region which is a boundary between display electrode pair groups.

In the method of driving the plasma display panel, the second driving mode may be set for at least one of the plural sub-fields based on length information of the sustain period in each of the sub-fields, which is performed with priority over selecting of the first driving mode or the second driving mode.

Depending on the length of the sustain period of the sub-field, suppressing generation of a luminance difference in the vicinity of a display region which is a boundary between display electrode pair groups is better than reducing an overall driving time. In that case, the second driving mode is set without fail without depending on a result of comparison between the length of the sustain period and the length of the wall voltage adjusting period. This makes it possible to ensure a sub-field number and suppress generation of a luminance difference in the vicinity of a display region which is a boundary between display electrode pair groups, in a well-balanced manner.

In the driving method of driving the plasma display panel, the second driving mode may be set for a sub-field with a longest sustain period, among the plural sub-fields.

Regarding the sub-field with a longest sustain period, voltages applied to discharge cells are made uniform, and thus, it is possible to suppress generation of a luminance difference in the vicinity of a display region which is a boundary between display electrode pair groups, by setting the second driving mode in which the sustain period and the wall voltage adjusting period of one display electrode pair group are synchronized with the sustain period and the wall voltage adjusting period of another display electrode pair groups, in the plural display electrode pair groups.

In the method of driving a plasma display panel, the second driving mode may be set for a sub-field with a second longest sustain period, among the plural sub-fields.

In a case where a luminance difference in the vicinity of a display region which is a boundary between display electrode pair groups is not sufficiently lessened by merely setting the second driving mode for the sub-field with a longest sustain period, it is desirable to set the second driving mode for the sub-field with a second longest sustain period, in the same manner.

In the method of driving the plasma display panel, the second driving mode may be set for at least one of the plural sub-fields based on number information of discharge cells which generate sustain discharge in each of the sub-fields, which is performed with priority over selecting of the first driving mode or the second driving mode.

Depending on the number of discharge cells which generate sustain discharge in the sub-field, suppressing generation of a luminance difference in the vicinity of a display region which is a boundary between display electrode pair groups is better than reducing an overall driving time. In that case, the second driving mode is set without fail without depending on a result of comparison between the length of the sustain period and the length of the wall voltage adjusting period. This makes it possible to ensure a sub-field number and suppress generation of a luminance difference in the vicinity of a display region which is a boundary between display electrode pair groups, in a well-balanced manner.

In the method of driving the plasma display panel, the second driving mode may be set for a sub-field in which the number of discharge cells which generate sustain discharge is largest, among the plural sub-fields.

Regarding the sub-field in which the number of discharge cells which generate sustain discharge is largest, voltages applied to discharge cells are made uniform, and thus, it is possible to suppress generation of a luminance difference in the vicinity of a display region which is a boundary between display electrode pair groups, by setting the second driving mode in which the sustain period and the wall voltage adjusting period of one display electrode pair group are synchronized with the sustain period and the wall voltage adjusting period of another display electrode pair groups, in the plural display electrode pair groups.

In the method of driving a plasma display panel, the second driving mode may be set for a sub-field in which the number of discharge cells which generate sustain discharge during the sustain period is second largest, among the plural sub-fields.

In a case where a luminance difference in the vicinity of a display region which is a boundary between display electrode pair groups is not sufficiently lessened by merely setting the second driving mode for the sub-field in which the number of discharge cells which generate sustain discharge is largest, it is desirable to set the second driving mode in the same manner for the sub-field in which the number of discharge cells which generate sustain discharge is second largest.

In the method of driving the plasma display panel, the second driving mode may be set for a sub-field just after a reset period in which all of the discharge cells generate reset discharge, which is performed with priority over selecting of the first driving mode or the second driving mode.

After all of the discharge cells generate discharge in the reset period, address discharge in the write period becomes intense. Therefore, a discharge crosstalk is easily generated between discharge cells. Therefore, lighting of the sub-field just after the reset period without fail is better. In this case, a lighting ratio of the sub-field just after the reset period has a highest lighting ratio in all sub-fields. By setting the second driving mode for the sub-field just after the reset period, it is possible to suppress generation of a luminance difference in the vicinity of a display region which is a boundary between display electrode pair groups.

To achieve the above object, a plasma display apparatus comprises a plasma display panel including plural display electrode pairs each including a scan electrode and a sustain electrode, and plural data electrodes, and having a structure in which discharge cells are respectively formed at locations where the display electrode pairs cross the data electrodes, respectively; and a driving circuit for driving the plasma display panel; each field constituting an image includes plural sub-fields; each of the sub-fields includes a write period during which the discharge cells generate write discharge, a sustain period during which the discharge cells which generated the write discharge generate sustain discharge, and a wall voltage adjusting period during which wall voltage of the discharge cells which generated the sustain discharge is adjusted for next write discharge; the driving circuit compares the sustain period to the wall voltage adjusting period, in each of the sub-fields, selects a first driving mode in which the plural display electrode pairs are divided into plural display electrode pair groups, the sustain period and the wall voltage adjusting period are set for each of the display electrode pair groups, and in a period in which one display electrode pair group is in the wall voltage adjusting period, successive write operation in display electrode pair groups other than the one display electrode pair group is restricted, if the sustain period is longer than the wall voltage adjusting period; or selects a second driving mode in which the sustain period and the wall voltage adjusting period are performed for all of the display electrode pairs in the plasma display panel, if the sustain period is shorter than the wall voltage adjusting period.

With this configuration, it is possible to easily ensure a sufficient sub-field number even in a high-definition plasma display panel and to suppress generation of a luminance difference in the vicinity of a display region which is a boundary between display electrode pair groups.

In the plasma display apparatus, the second driving mode may be set for at least one of the plural sub-fields based on length information of the sustain period in each of the sub-fields, which is performed with priority over selecting of the first driving mode or the second driving mode.

In the plasma display apparatus, the second driving mode may be set for a sub-field with a longest sustain period, among the plural sub-fields.

In the plasma display apparatus, the second driving mode may be set for a sub-field with a second longest sustain period, among the plural sub-fields.

In the plasma display apparatus, the second driving mode may be set for at least one of the plural sub-fields based on number information of discharge cells which generate sustain discharge in each of the sub-fields, which is performed with priority over selecting of the first driving mode or the second driving mode.

In the plasma display apparatus, the second driving mode may be set for a sub-field in which the number of discharge cells which generate sustain discharge is largest, among the plural sub-fields.

In the plasma display apparatus, the second driving mode may be set for a sub-field in which the number of discharge cells which generate sustain discharge during the sustain period is second largest, among the plural sub-fields.

In the plasma display apparatus, the second driving mode may be set for a sub-field just after a reset period in which all of the discharge cells generate reset discharge, which is performed with priority over selecting of the first driving mode or the second driving mode.

To achieve the above object, a plasma display apparatus comprises a plasma display panel including plural display electrode pairs each including a scan electrode and a sustain electrode, and plural data electrodes, and having a structure in which discharge cells are respectively formed at locations where the display electrode pairs cross the data electrodes, respectively; a scan electrode driving circuit for driving plural scan electrodes; a sustain electrode driving circuit for driving plural sustain electrodes; a data electrode driving circuit for driving plural data electrodes; and a timing generating circuit for outputting timing signals to the image processing signal circuit, the scan electrode driving circuit, the sustain electrode driving circuit and the data electrode driving circuit based on an image signal and a synchronous signal; each field constituting an image includes plural sub-fields; each of the sub-fields includes a write period during which the discharge cells generate write discharge, a sustain period during which the discharge cells which generated the write discharge generate sustain discharge, and a wall voltage adjusting period during which wall voltage of the discharge cells which generated the sustain discharge is adjusted for next write discharge; the timing generating circuit compares the sustain period to the wall voltage adjusting period, in each of the sub-fields, selects a first driving mode in which the plural display electrode pairs are divided into plural display electrode pair groups, the sustain period and the wall voltage adjusting period are set for each of the display electrode pair groups, and in a period in which one display electrode pair group is in the wall voltage adjusting period, successive write operation in display electrode pair groups other than the one display electrode pair group is restricted, if the sustain period is longer than the wall voltage adjusting period; or selects a second driving mode in which the sustain period and the wall voltage adjusting period are performed for all of the display electrode pairs in the plasma display panel, if the sustain period is shorter than the wall voltage adjusting period.

### Advantageous Effects of the Invention

In accordance with the present invention, it is possible to provide a driving method of a plasma display panel in which a sufficient sub-field number is ensured even in a high-definition plasma display panel, and a luminance difference is less likely to be generated in the vicinity of a display region which is a boundary between display electrode pair groups, and a plasma display apparatus using the driving method.

### BRIEF DESCRIPTION OF THE DRAWINGS

FIG. 1 is an exploded perspective view of a plasma display panel of a plasma display apparatus according to Embodiment 1 of the present invention.

FIG. 2 is a view of electrode arrangement in the plasma display panel of the plasma display apparatus.

FIG. 3 is a view showing a setting method of a sub-field configuration of the plasma display apparatus.

FIG. 4 is a view showing driving voltage waveforms applied to electrodes of the plasma display panel of the plasma display apparatus.

FIG. 5 is a circuit block diagram of the plasma display apparatus.

FIG. 6 is a circuit diagram of a scan electrode driving circuit in the plasma display apparatus.

FIG. 7 is a circuit diagram of a sustain electrode driving circuit in the plasma display apparatus.

FIG. 8 is a view showing an operation of the scan electrode driving circuit in the plasma display apparatus.

FIG. 9 is a view showing an operation of the sustain electrode driving circuit in the plasma display apparatus.

FIG. 10 is a view showing a driving method of the plasma display panel according to Embodiment 1 of the present invention.

FIG. 11 is a view showing a setting method of a sub-field configuration of a plasma display apparatus according to Embodiment 2 of the present invention.

FIG. 12 is a view showing a setting method of a sub-field configuration of a plasma display apparatus according to Embodiment 3 of the present invention.

FIG. 13 is a view showing a setting method of a sub-field configuration of a plasma display apparatus according to Embodiment 4 of the present invention.

### DESCRIPTION OF THE EMBODIMENTS

Hereinafter, a driving method of a plasma display panel (hereinafter referred to as “plasma display panel”) and a plasma display apparatus according to embodiments of the present invention will be described with reference to the drawings.

### Embodiment 1

<Configuration of Plasma Display Panel 10>

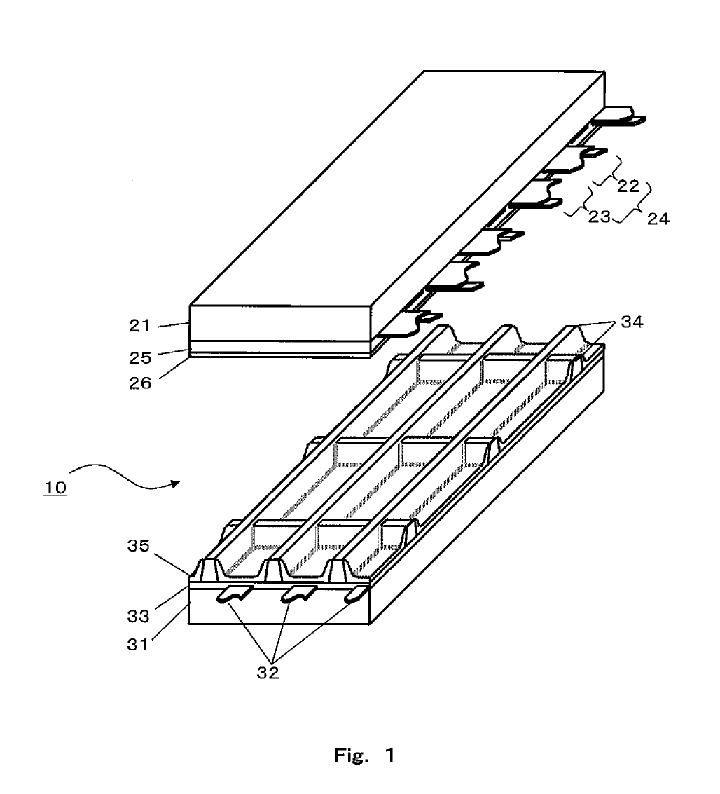

FIG. 1 is an exploded perspective view of a plasma display panel 10 of a plasma display apparatus according to Embodiment 1 of the present invention. Plural display electrode pairs 24 each including a scan electrode 22 and a sustain electrode 23 are formed on a glass-made front substrate 21. A dielectric layer 25 and a protective layer 26 are stacked in this order on the front substrate 21 so as to cover the display electrode pairs 24.

Plural data electrodes 32 are formed to extend in parallel with each other on a back substrate 31. A dielectric layer 33 is formed on the back substrate 31 so as to cover the data electrodes 32. Lattice-shaped separating walls 34 are formed on the dielectric layer 33. A phosphor layer 35 is provided in a space defined by the upper surface of the dielectric layer 33 and the side surfaces of the separating walls 34 to emit light of red, green, and blue.

The front substrate 21 and the back substrate 31 formed as described above are disposed so as to face each other and so as to sandwich a small discharge space such that the display electrode pairs 24 three-dimensionally cross (hereinafter simply referred to as cross) the data electrodes 32. The outer peripheral portions of the front substrate 21 and the back substrate 31 are sealed by a sealing material such as glass frit. For example, a rare gas such as neon, argon, or xenon, or a mixture gas of these is filled into an inner discharge space of the front substrate 21 and the back substrate 31 as a discharge gas. The inner discharge space is separated into plural spaces by the separating walls 34. In this way, a plasma display panel 10 according to Embodiment 1 is constructed, and discharge cells are formed at portions where the display electrode pairs 24 cross the data electrodes 32. Within the respective discharge cells, ultraviolet light generated by the gas discharge causes respective phosphors to be excited so as to emit light, and thereby color display is performed. The configuration of the plasma display panel 10 is not limited to the above described configuration, but stripe-shaped separating walls 34 may be provided, for example.

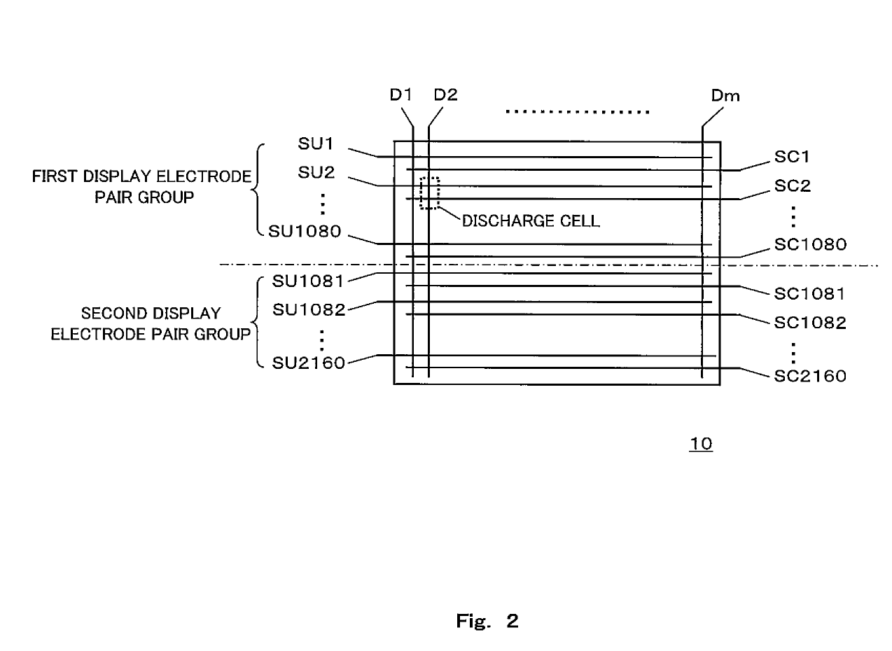

FIG. 2 is a view of electrode arrangement of the plasma display panel 10 according to Embodiment 1 of the present invention. In the plasma display panel 10, n scan electrodes SC1˜SCn (scan electrode 22 of FIG. 1) and n sustain electrodes SU1˜SUn (sustain electrode 23 of FIG. 1) are arranged to extend in a row direction, and m data electrodes D1˜Dm (data electrode 32 of FIG. 1) are arranged to extend in a column direction. A discharge cell is formed at a portion where the pair of scan electrode SCi (i=1˜n) and sustain electrode SUi (i=1˜n) cross one data electrode Dj (j=1˜m), for example. In other words, (m×n) discharge cells are formed as a whole within the discharge space. The number of display electrode pairs is not particularly limited, but in Embodiment 1, n=2160.

2160 display electrode pairs (display electrode pairs 24 shown in FIG. 1) comprising the scan electrodes SC1˜SC2160 and the sustain electrodes SU1˜SU2160 are divided into plural display electrode pair groups. In Embodiment 1, as shown in FIG. 2, the plasma display panel 10 is divided into upper and lower parts, and the display electrode pairs (sustain electrodes SU1˜SU1080 and scan electrodes SC1˜SC1080) positioned at the upper part of the plasma display panel 10 are a first display electrode pair group, while the display electrode pairs (sustain electrodes SU1081˜SU2160 and scan electrodes SC1081˜SC2160) positioned at the lower part of the plasma display panel 10 are a second display electrode pair group. How to decide number N of the display electrode pair groups will be explained later.

[Driving Method of Plasma Display Panel 10]

Subsequently, a driving method of the plasma display panel 10 will be described. In Embodiment 1, timings of a scan pulse voltage and a write pulse voltage are set so that a write (address) operation occurs continuously in all of the display electrode pair groups except for the reset period. As a result, sub-fields of a maximum number can be set within each field period constituting an image, which will be described in detail hereinafter.

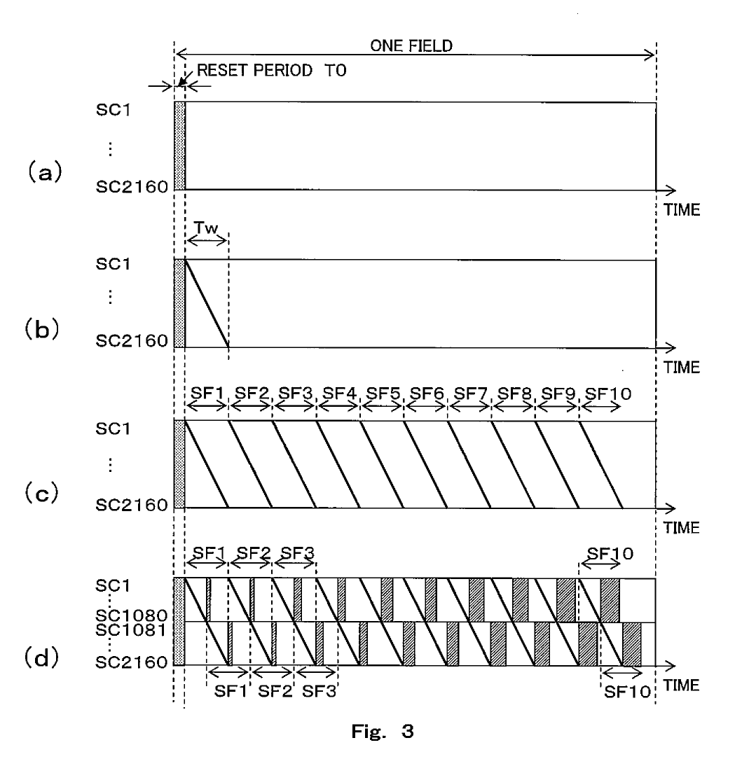

FIG. 3 is a view showing a setting method of a sub-field configuration of the plasma display apparatus according to Embodiment 1 of the present invention. In FIG. 3(a)˜FIG. 3(d), vertical axis indicates scan electrodes SC1˜SC2160, and horizontal axis indicates time. Timings when the write operation is performed are indicated by solid lines and timings of sustain periods and erase periods described later are hatched. In description below, a time of one field period is set to 16.7 ms.

As shown in FIG. 3(a), firstly, in an initial period of one field period, a time required for a reset period T0 when reset discharge is generated in all of discharge cells in the plasma display panel 10 is set. In Embodiment 1, the time required for the reset period T0 is set to 500 μs (0.5 ms).

Next, as shown in FIG. 3(b), a time Tw required to sequentially apply a scan pulse voltage to the scan electrodes SC1˜SC2160 is estimated. In this case, it is desirable to apply the scan pulse voltage as short as possible and as continuously as possible so that the write operation is performed continuously with respect to the scan electrodes SC1˜SC2160. In Embodiment 1, a time Tw0 required for the write operation for a single scan electrode is set to 0.7 μs. Since the number of scan electrodes is 2160, a time Tw required to perform the write operation once for all of the scan electrodes SC1˜SC2160 is 0.7×2160=1512 μs (about 1.5 ms).

Next, the number of sub-fields within one field is estimated. Herein, a time required for the erase period is assumed to be negligible, and the time (0.5 ms) of the reset period T0 is subtracted from the time (16.7 ms) of one field period and the resulting time is divided by the time (about 1.5 ms) required to perform the write operation once for all of the scan electrodes SC1˜SC2160, thereby resulting in (16.7−0.5)/1.5=10.8. In this case, as shown in FIG. 3(c), 10 sub-fields at maximum (SF1, SF2, . . . , SF10) can be ensured within one field.

Next, the number N of the display electrode pair groups into which the display electrode pairs 24 are divided is decided. To be specific, in Embodiment 1, sustain pulse voltages of “1T”, “2T”, “3T”, “4T”, “6T”, “11T”, “18T”, “30T”, “44T”, and “60T” (1T represents one cycle of the sustain pulse voltage) are sequentially applied to the sub-fields SF1˜SF10, respectively, and 1T which is one cycle of the sustain pulse voltage is 10 μs. So, a longest time Ts required to apply the sustain pulse voltage is 10×60=600 μs. The number N of the display electrode pair groups is calculated according to a following formula using the time Tw required to perform a write operation once in all of the scan electrodes and the longest time Ts required to apply the sustain pulse voltage:

N≧Tw/(Tw−Ts) (formula 1)

In Embodiment 1, Tw=1512 μs and Ts=600 μs. These are assigned to a right side, which results in 1512/(1512−600)=1.66. The number N of the display electrode pair groups is 2. Accordingly, in Embodiment 1, as shown in FIG. 2, the display electrode pairs of the plasma display panel 10 are divided into upper and lower parts which are a first display electrode pair group and a second display electrode pair group.

The two display electrode pair groups may be interlaced into the odd-number-th display electrode pairs and even-number-th display electrode pairs, in the plasma display panel 10. To be specific, the scan electrodes SC1, SC3, . . . SC2159 and the sustain electrodes SU1, SU3, . . . , SU2159 may be the first display electrode pair group, while the scan electrodes SC2, SC4, . . . SC2160 and the sustain electrodes SU2, SU4, . . . SU2160 may be the second display electrode pair group (not shown). By using interlacing, a luminance difference between the display electrode pair groups is lessened and an image quality of the plasma display panel 10 is improved.

As shown in FIG. 3(d), after writing to the scan electrodes belonging to each display electrode pair group, a sustain period is provided to apply the sustain pulse voltage. Although erase period follows the end of the sustain period in each sub-field, in FIG. 3(d), the sustain period and the erase period are both hatched by oblique lines from right and upper to left and lower, for the sake convenience.

### <Driving Voltage Waveform of Plasma Display Panel 10>

Subsequently, a detail of driving voltage waveforms and an operation for generating the driving voltage waveforms will be described.

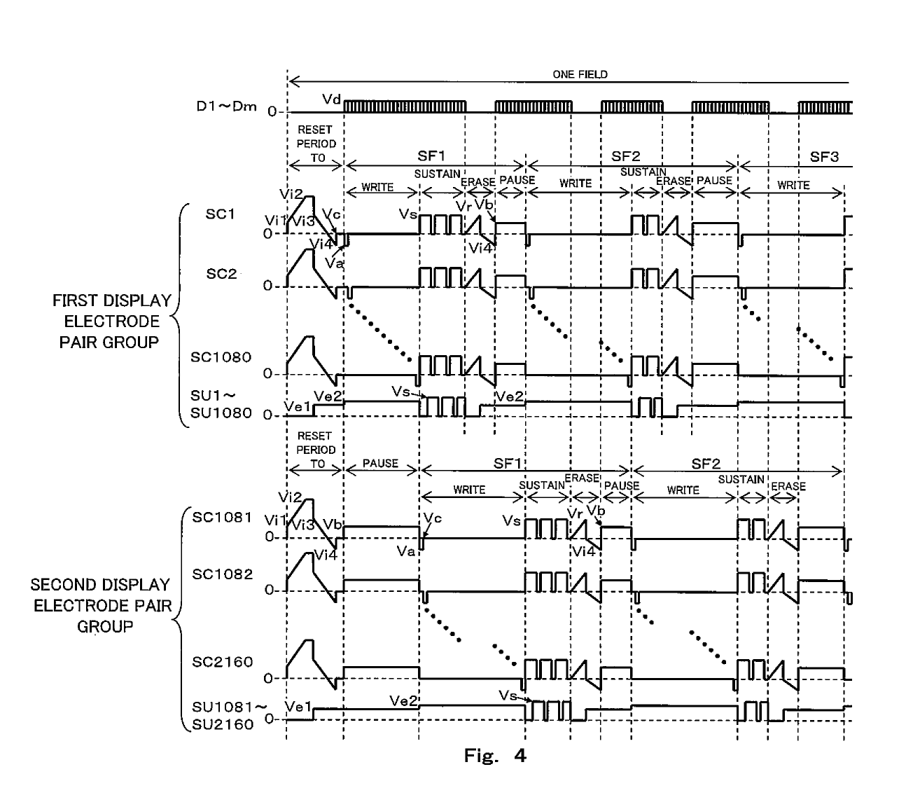

FIG. 4 is a view showing driving voltage waveforms applied to the electrodes of the plasma display panel 10 according to Embodiment 1 of the present invention. In an initial part of one field, a reset period T0 is provided to generate reset discharge in all of the discharge cells. For each display electrode pair group, each sub-field has a write(address) period, a sustain period, an erase period and a pause period. For the sake of convenience, FIG. 4 shows the reset period T0, all periods of the sub-fields SF1˜SF2, and a write period of the sub-field SF3, for the first display electrode pair group, and the reset period T0 and all periods of the sub-fields SF1˜SF2, for the second display electrode pair group.

The write period is a period during which write discharge is selectively generated according to an image to be displayed to form a wall voltage (wall charge) required for next sustain discharge on each electrode. The sustain period is a period during which sustain discharge is generated for a time according to a luminance weight. The erase period is a period during which erase discharge is generated to erase unnecessary wall voltage (wall charge). The pause period is a period during which no discharge is generated between an erase period in a certain sub-field and a write period in a subsequent sub-field and reduction of wall charge is suppressed.

Considering roles of the erase period and the pause period, these periods may be regarded as periods for adjusting the wall voltage (wall charge) for a next write operation (to allow a next write operation to be performed properly), in a period between a sustain period in a certain sub-field and a write period in a subsequent sub-field. In the present invention, accordingly, a period between a sustain period in a certain sub-field and a write period in a subsequent sub-field is referred to as “wall voltage adjusting period.” In the example shown in FIG. 4, the erase period and the pause period correspond to “wall voltage adjusting period.” Alternatively, “wall voltage adjusting period” may consist of the erase period, without providing the pause period.

First of all, the reset period T0 set as a common period for the first display electrode pair group and the second display electrode pair group will be described.

In the reset period T0, the voltage 0(V) is applied to the data electrodes D1˜Dm and to the sustain electrodes SU1˜SU2160, while a ramp waveform voltage gently rising from a voltage Vi1 toward a voltage Vi2 is applied to the scan electrodes SC1˜SC2160. During rising of the ramp waveform voltage, weak reset discharge is generated between the scan electrodes SC1˜SC2160 and the sustain electrodes SU1˜SU2160, and between the scan electrodes SC1˜SC2160 and the data electrodes D1˜Dm. Thereby, negative wall voltage is accumulated on the scan electrodes SC1˜SC2160 and positive wall voltage is accumulated on the data electrodes D1˜Dm and on the sustain electrodes SU1˜SU2160. As used herein, the wall voltage on electrode represents a voltage generated by the wall charge accumulated on a dielectric layer, a protective layer, a phosphor layer, etc, covering the electrodes. Note that during this period, the voltage Vd may be applied to the data electrodes D1˜Dm.

Then, a positive constant voltage Ve1 is applied to the sustain electrodes SU1˜SU2160, while a ramp waveform voltage gently falling from a voltage Vi3 to a voltage Vi4 is applied to the scan electrodes SC1˜SC2160. During this period, weak reset discharge is generated between the scan electrodes SC1˜SC2160 and the sustain electrodes SU1˜SU2160, and the data electrodes D1˜Dm. This lessens a negative wall voltage on the scan electrodes SC1˜SC2160 and a positive wall voltage on the sustain electrodes SU1˜SU2160, are lessened, while a positive wall voltage on the data electrodes D1˜Dm is adjusted to value suitable for a write operation.

Thereafter, a voltage Vc is applied to the scan electrodes SC1˜SC2160, thereby terminating a reset operation for performing a reset discharge to all of the discharge cells.

Subsequently, the write period in the sub-field SF1 for the first display electrode pair group, and the pause period in the sub-field SF1 for the second display electrode pair group which is set as a period identical to that write period will be described.

In the write period of the sub-field SF1 for the first display electrode pair group, writing is performed for 1st line to 1080-th line in the first display electrode pair group, according to a single scan method, as described below.

A positive constant voltage Ve2 is applied to the sustain electrodes SU1˜SU1080. A scan pulse voltage having a negative voltage Va is applied to the scan electrode SC1 on 1st line and a write pulse voltage having a positive voltage Vd is applied to data electrode Dk (k is one of 1˜m) corresponding to a discharge cell which should emit light on 1st line. A voltage difference at a cross portion on the data electrode Dk and on the scan electrode SC1 is a sum of a difference in outside application voltages (write pulse voltage Vd˜scan pulse voltage Va) and a difference between the wall voltage on the data electrode Dk and the wall voltage on the scan electrode SC1, and exceeds a discharge start voltage. Thereby, discharge between the data electrode Dk and the scan electrode SC1 starts, and develops into discharge between the sustain electrode SU1 and the scan electrode SC1. Thus, write discharge is generated. As a result, a positive wall voltage is accumulated on the scan electrode SC1, a negative wall voltage is accumulated on the sustain electrode SU1 and the negative wall voltage is accumulated on the data electrode Dk.

In the manner as described above, write discharge is generated in the discharge cells which should emit light on 1st line, to perform a write operation for accumulating the wall voltage on each electrode. On the other hand, a voltage at the cross portion of the data electrode Dk to which the write pulse voltage Vd is not applied and the scan electrode SC1 does not exceed the discharge start voltage, and therefore no write discharge is generated.

Then, the scan pulse voltage Va is applied to the scan electrode SC2 on 2nd line and the write pulse voltage Vd is applied to data electrode Dk corresponding to a discharge cell which should emit light on 2nd line. In the discharge cell on 2nd line which is applied with the scan pulse voltage Va and the write pulse voltage Vd simultaneously, write discharge is generated, and thus, a write operation is performed.

The above mentioned operation is repeated for the discharge cell on 1080-th line belonging to the first display electrode pair group to cause the discharge cell which should emit light for each line in the first display electrode pair group to selectively generate the write discharge, to form the wall charge.

During the write period for the first display electrode pair group, a voltage Vb higher than the voltage Vc applied to the scan electrodes SC1˜SC1080 belonging to the first display electrode pair group, is applied to the scan electrodes SC1081˜SC2160 belonging to the second display electrode pair group. Thereby, in the second display electrode pair group, a pause period in which no discharge is generated is set. In this way, during the pause period, the scan electrodes SC1081˜SC2160 are held at an electric potential as high as possible provided that no discharge is generated. As a result, reduction of the wall charge is suppressed and a stable write operation is performed in the following write period. It should be noted that the voltages applied to the respective electrodes belonging to the second display electrode pair group are not limited to the above, but may be another voltage may be applied to them provided that no discharge is generated.

Subsequently, the write period in the sub-field SF1 for the second display electrode pair group, and the sustain period, the erase period and the pause period in the sub-field SF1 for the first display electrode pair group which are set as the periods included in this write period, will be described.

In the write period of the sub-field SF1 for the second display electrode pair group, writing is performed sequentially for 1081-th line to 2160-th line in the second display electrode pair group, according to the single scan method, as described below.

A positive constant voltage Ve2 is applied to the sustain electrodes SU1081˜SU2160. The scan pulse voltage Va is applied to the scan electrode SC1081 on 1081-th line and the write pulse voltage Vd is applied to data electrode Dk (k is one of 1˜m) corresponding to a discharge cell which should emit light on 1081-th line. Thereby, write discharge is generated between the data electrode Dk and the scan electrode SC1081 and between the sustain electrode SU1081 and the scan electrode SC1081.

The scan pulse voltage Va is applied to the scan electrode SC1082 on 1082-th line and the write pulse voltage Vd is applied to data electrode Dk (k is one of 1˜m) corresponding to a discharge cell which should emit light on 1082-th line. Thereby, in the discharge cell on 1082-th line which is applied with the scan pulse voltage Va and the write pulse voltage Vd simultaneously, a write discharge is generated.

The above mentioned operation is repeated for the discharge cell on 2160-th line to cause the discharge cell which should emit light for each line in the second display electrode pair group to selectively generate the write discharge, to form the wall charge.

In the write period for the second display electrode pair group, the sustain period is initially set in the sub-field SF1 for the first display electrode pair group. To be specific, a sustain voltage Vs of “1T” is applied alternately to the scan electrodes SC1˜SC1080 and the sustain electrodes SU1˜SU1080 belonging to the first display electrode pair group, thereby allowing the discharge cells which performed the write discharge to emit light.

To be specific, the sustain pulse voltage of a positive voltage Vs is applied to the scan electrodes SC1˜SC1080 and a voltage 0 (V) is applied to the sustain electrodes SU1˜SU1080. In the discharge cell which generated the write discharge, a voltage difference between a scan electrode SCi (i is one of 1˜1080) and a sustain electrode SUi (i is one of 1˜1080) is a sum of the sustain pulse voltage Vs and a difference between a wall voltage on the scan electrode SCi and a wall voltage on the sustain electrode SUi and exceeds the discharge start voltage. Thus, sustain discharge is generated between the scan electrode SCi and the sustain electrode SUi, and excites a discharge gas. In addition, a ultraviolet ray generated when the excited discharge gas transitions to a stable condition allows the phosphor layer 35 to emit light. As a result, a negative wall voltage is accumulated on the scan electrode SCi and a positive wall voltage is accumulated on the sustain electrode SUi.

In contrast, in the discharge cells which did not generate the write discharge during the write period, no sustain discharge is generated, and the wall voltage at the end of the reset period is maintained.

Then, a voltage 0(V) is applied to the scan electrodes SC1˜SC1080, while the sustain pulse voltage Vs is applied to the sustain electrodes SU1˜SU1080. In the discharge cell which generated the sustain discharge, sustain discharge is generated again because the difference between the voltage on the sustain electrode SUi and the voltage on the scan electrode SCi exceeds the write discharge start voltage. As a result, a negative wall voltage is accumulated on the sustain electrode SUi and a positive wall voltage is accumulated on the scan electrode SCi.

Thereafter, in the same manner, the sustain pulse voltage Vs is applied alternately to the scan electrodes SC1˜SC1080 and the sustain electrodes SU1˜SU1080 to provide an electric potential difference between the electrodes of the display electrode pair. Thus, the discharge cells which generated the write discharge in the write period continued to perform the sustain discharge.

The sustain pulse voltage Vs applied alternately to the scan electrodes SC1˜SC1080 and to the sustain electrodes SU1˜SU1080 has timings at which the scan electrodes SC1˜SC1080 and the sustain electrodes SU1˜SU1080 are at high electric potentials simultaneously. To be specific, in a case where the positive sustain pulse voltage Vs is applied to the scan electrodes SC1˜SC1080 and the voltage 0(V) is applied to the sustain electrodes SU1˜SU1080, the voltage of the scan electrodes SC1˜SC1080 is raised from the voltage 0(V) toward the sustain pulse voltage Vs, and then the voltage of the sustain electrodes SU1˜SU1080, is decreased from the sustain pulse voltage Vs toward the voltage 0(V). In a case where the voltage 0(V) is applied to the scan electrodes SC1˜SC1080 and the positive sustain voltage Vs is applied to the sustain electrodes SU1˜SU1080, the voltage of the sustain electrodes SU1˜SU1080 is raised from the voltage 0(V) toward the sustain pulse voltage Vs, and then the voltage of the scan electrodes SC1˜SC1080, is decreased from the sustain pulse voltage Vs toward the voltage 0(V).

In the manner as described above, the sustain pulse voltage Vs is applied alternately to the scan electrodes SC1˜SC1080 and to the sustain electrodes SU1˜SU1080 such that there are timings when the scan electrodes SC1˜SC1080 and the sustain electrodes SU1˜SU1080 are at high electric potentials simultaneously. As a result, stable sustain discharge can continue without being affected by the write pulse voltage Vd applied to the data electrode. The reason is as follows.

Here, it is assumed that the voltage of the scan electrodes SC1˜SC1080 is decreased from the sustain pulse voltage Vs toward the voltage 0(V) and then the voltage of the sustain electrodes SU1˜SU1080 is raised from the voltage 0(V) toward the sustain pulse voltage Vs, in a case where the voltage 0(V) is applied to the scan electrodes SC1˜SC1080 and the sustain pulse voltage Vs is applied to the sustain electrodes SU1˜SU1080. In this case, there is a chance that when the write pulse voltage Vd is applied to the data electrode Dk, discharge is generated between the scan electrodes SC1˜SC1080 and the data electrodes Dk at a time point when the voltage of the scan electrodes SC1˜SC1080 has decreased, and wall charge required to continue sustain discharge is reduced.

Here, it is assumed that the voltage of the sustain electrodes SU1˜SU1080 is decreased from the sustain pulse voltage Vs toward the voltage 0(V) and then the voltage of the scan electrodes SC1˜SC1080 is raised from the voltage 0(V) toward the sustain pulse voltage Vs, in a case where the sustain pulse voltage Vs is applied to the scan electrodes SC1˜SC1080 and the voltage 0(V) is applied to the sustain electrodes SU1˜SU1080. In this case, there is a chance that when the write pulse voltage Vd is applied to the data electrode Dk, discharge is generated between the sustain electrodes SU1˜SU1080 and the data electrodes Dk at a time point when the voltage of the sustain electrodes SU1˜SU1080 has decreased, and wall charge required to continue sustain discharge is reduced.

In a case where the discharge is generated and the wall charge is reduced at a time point when the voltage of either the scan electrodes SC1˜SC1080 or the sustain electrodes SU1˜SU1080 belonging to the first display electrode pair group is decreased from the sustain pulse voltage Vs toward the voltage 0(V), no sustain discharge is generated or otherwise weak sustain discharge is generated even when the voltage of the other electrodes is raised from the voltage 0(V) toward the sustain pulse voltage Vs, so that sufficient wall charge is not accumulated. For this reason, there is a chance that the sustain discharge cannot be generated continuously.

However, in Embodiment 1, the voltage of either the scan electrodes SC1˜SC1080 or the sustain electrodes SU1˜SU1080 belonging to the first display electrode pair group is raised from the voltage 0(V) toward the sustain pulse voltage Vs, and then the voltage of the other electrodes is decreased from the sustain pulse voltage Vs toward the voltage 0(V). For this reason, there is no possibility that discharge between one electrode and the data electrodes Dk precedes, if the write pulse voltage Vd is applied to the data electrode Dk. As a result, in Embodiment 1, the sustain discharge can continue stably regardless of presence/absence of the write pulse voltage Vd.

There is an erase period after the sustain period of the sub-field SF1 for the first display electrode pair group. In this erase period, a ramp waveform voltage rising toward a voltage Vr is applied to the scan electrodes SC1˜SC1080 and then the voltage 0(V) is applied to them. Thereafter, a constant voltage Ve1 is applied to the sustain electrodes SU1˜SU1080, and then a ramp waveform voltage falling toward a voltage Vi4 is applied to the scan electrodes SC1˜SC1080. In this way, the wall voltage on the scan electrode SCi and the wall voltage on the sustain electrode SUi are erased in a state where the positive wall voltage on the data electrode Dk is left.

To perform the above erase operation of the wall voltage, some time is required. During the erase period, the wall voltage is erased and the wall voltage on the data electrode is adjusted for a write operation in a next write period. For this reason, it is desirable to fix the voltage of the data electrode Dk. Therefore, in Embodiment 1, during the erase period for one of the first display electrode pair group and the second display electrode pair group, the write operation for the other display electrode pair group is stopped.

After the erase period for the first display electrode pair group, a voltage Vb higher than the voltage Vc applied to the scan electrodes SC1081˜SC2160 belonging to the second display electrode pair group is applied to the scan electrodes SC1˜SC1080 belonging to the first display electrode pair group. Thus, for the first display electrode pair group, a pause period in which no discharge is generated is set. In this way, during the pause period, the scan electrodes SC1˜SC1080 are kept at electric potentials as high as possible provided that no discharge is generated. As a result, reduction of the wall charge is suppressed, and a stable write operation is performed in the write period in the following sub-field SF2

Subsequently, a write period in the sub-field SF2 for the first display electrode pair group, and a sustain period, an erase period and a pause period in the sub-field SF1 for the second display electrode pair group which are set as the periods included in this write period, will be described.

Initially, in the write period of the sub-field SF2 for the first display electrode pair group, a constant voltage Ve2 is applied to the sustain electrodes SU1˜SU1080. The scan pulse voltage Va is sequentially applied to the scan electrodes SC1˜SC1080 and the write pulse voltage Vd is applied to the data electrode Dk, like the write period of SF1. Thus, a write operation is performed in discharge cells on 1st line ˜1080-th line.

During the write period in the sub-field SF2 for the first display electrode pair group, the sustain period in the sub-field SF1 is set for the second display electrode pair group. To be specific, the sustain pulse voltage Vs of “1T” is applied alternately to the scan electrodes SC1081˜SC2160 and to the sustain electrodes SU1081˜SU2160, and discharge cells which performed write discharge emit light. The sustain pulse voltage Vs applied alternately to the scan electrodes SC1081˜SC2160 and to the sustain electrodes SU1081˜SU2160 has timings at which the scan electrodes SC1081˜SC2160 and the sustain electrodes SU1081˜SU2160 are at high electric potentials simultaneously.

An erase period is set after the sustain period of the sub-field SF1 for the second display electrode pair group. In this erase period, a ramp waveform voltage rising from the voltage 0(V) toward a voltage Vr is applied to the scan electrodes SC1081˜SC2160 and then the voltage 0(V) is applied thereto. Thereafter, a constant voltage Ve1 is applied to the sustain electrodes SU1081˜SU2160, and then a ramp waveform voltage falling toward a voltage Vi4 is applied to the scan electrodes SC1081˜SC2160. In this way, the wall voltage on the scan electrode SCi and the wall voltage on the sustain electrode SUi are erased in a state where the positive wall voltage on the data electrode Dk is left.

After the erase period in the sub-field SF1 for the second display electrode pair group, a pause period in which no discharge is generated is set. During this pause period, a voltage Vb higher than the voltage Vc is applied to the scan electrodes SC1081˜SC2160. This pause period continues until the write period for the first display electrode pair group ends.

Thereafter, in the same manner, the write period in the sub-field SF2 for the second display electrode pair group, the write period in the sub-field SF3 for the first display electrode pair group, and the write period in the sub-field SF10 for the second display electrode pair group, occur. Finally, the sustain period and the erase period in the sub-field SF10 for the second display electrode pair group are set. Thus, one field ends.

As described above, in Embodiment 1, after the reset period T0, the timings of the scan pulse voltage Va and the write pulse voltage Vd are set so that the write operation is performed successively for the first display electrode pair group and the second display electrode pair group. As a result, the sub-fields included within one field period can be ensured sufficiently in number. In Embodiment 1, the number of sub-fields is set to 10.

In Embodiment 1, the voltage Vi1 is 150(V), the voltage Vi2 is 400(V), the voltage Vi3 is 200(V), the voltage Vi4 is ˜150(V), the voltage Vc is −10(V), the voltage Vb is 150(V), the voltage Va is −160(V), the voltage Vs is 200(V), the voltage Vr is 200(V), the voltage Ve1 is 140(V), the voltage Ve2 is 150(V), and the voltage Vd is 60(V). A slope of the rising ramp waveform voltage applied to the scan electrodes SC1˜SC2160 is 10(V/μs) and a slope of the falling ramp waveform voltage applied to the scan electrodes SC1˜SC2160 is −2(V/μs). However, these voltage values and the slopes are not limited to the above illustrated values, but it is desirable to set these values optimally based on a discharge property of a plasma display panel 10 and a specification of the plasma display apparatus.

[Driving Circuit of Plasma Display Apparatus]

Next, a driving circuit of the plasma display apparatus of Embodiment 1 will be described.

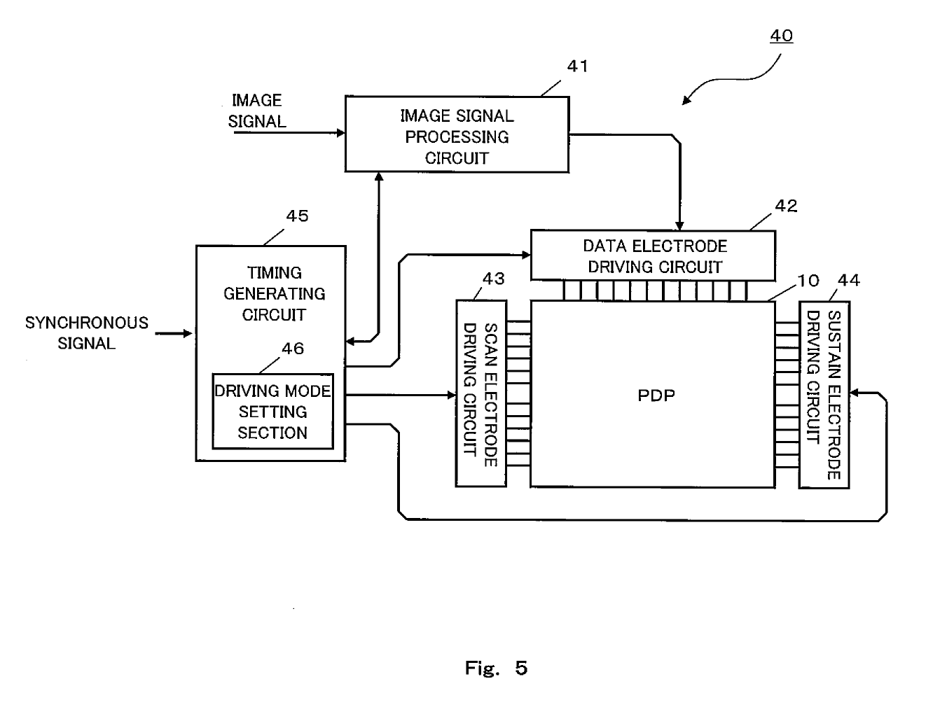

FIG. 5 is a circuit block diagram of the plasma display apparatus 40 of Embodiment 1 of the present invention. The plasma display apparatus 40 comprises the plasma display panel 10, an image signal processing circuit 41, a data electrode driving circuit 42, a scan electrode driving circuit 43, a sustain electrode driving circuit 44, a timing generating circuit 45 including a driving mode setting section 46 and an electric power supply circuit (not shown) for supplying an electric power required for each circuit block.

The image signal processing circuit 41 converts an image signal input externally into image data exhibiting light emission or light non-emission in each sub-field.

The data electrode driving circuit 42 has m switches through which the write pulse voltage Vd or the voltage 0V is applied to the respective of m data electrodes D1˜Dm, converts the image data output from the image signal processing circuit 41 into write pulse voltage Vd corresponding to the data electrodes D1˜Dm and apply it to the data electrodes D1˜Dm.

The timing generating circuit 45 generates various timing signals used for controlling the operation of the circuits 41, 42, 43, and 44 based on synchronization signals (horizontal synchronization signal and vertical synchronization signal) and lighting-ratio information from the image signal processing circuit 41, and send the timing signals to the associated circuits 41, 42, 43, 44. To be specific, the timing generating circuit 45 generates a field start signal at a time point after a specified time lapses from the vertical synchronization signal, and generates timing signals for commanding start of the write period, the sustain period, the erase period, etc in each sub-field, starting from the field start signal. Further, the timing generating circuit 45 counts clocks starting from the timing signal commanding start of each period, generates the timing signals for commanding the timings of pulse generation, and supplies them to the circuits 41, 42, 43, and 44.

The timing generating circuit 45 includes the driving mode setting section 46. The driving mode setting section 46 selects a driving mode (hereinafter referred to as “first driving mode”) for setting the sustain period and the erase period in a sub-field, for each display electrode pair group, or a driving mode (hereinafter referred to as “second driving mode”) for setting the sustain period and the erase period in the sub-field such that the sustain period and erase period of one display electrode pair group are synchronized with those of another display electrode pair group, for each sub-field included in one field. How to select the first driving mode or the second driving mode will be described in detail later. The timing generating circuit 45 generates timing signals in accordance with the first driving mode or the second driving mode selected by the driving mode setting section 46 and outputs the timing signals. The driving mode setting section 46 is implemented by a microcomputer or FPGA.

The scan electrode driving circuit 43 drives the scan electrodes SC1˜SC1080 belonging to the first display electrode pair group and the scan electrodes SC1081˜SC2160 belonging to the second display electrode pair group, based on the timing signals supplied from the timing generating circuit 45. The sustain electrode driving circuit 44 drives the sustain electrodes SU1˜SU1080 belonging to the first display electrode pair group and the sustain electrodes SU1081˜SU2160 belonging to the second display electrode pair group, based on the timing signals supplied from the timing generating circuit 45.

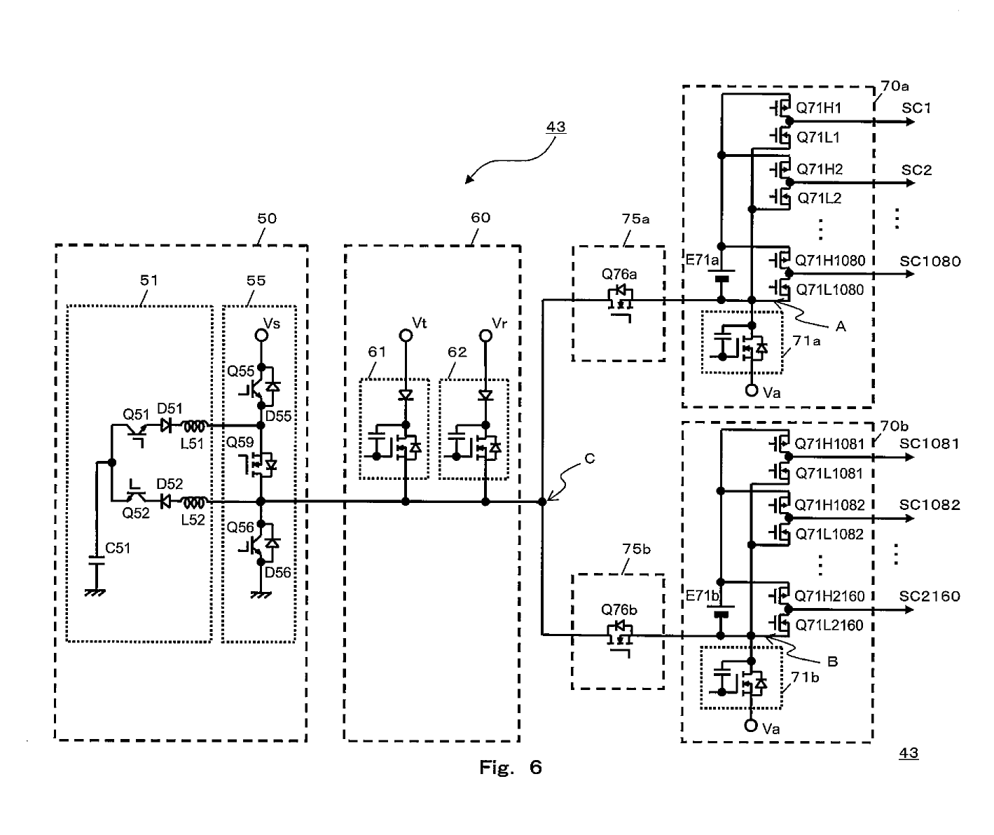

FIG. 6 is a circuit diagram of the scan electrode driving circuit 43 of the plasma display apparatus 40 according to Embodiment 1 of the present invention. The scan electrode driving circuit 43 includes a scan electrode side sustain pulse generating circuit 50 (hereinafter simply referred to as “sustain pulse generating circuit 50”), a ramp waveform generating circuit 60, a first display electrode pair group side scan pulse generating circuit 70a (hereinafter simply referred to as “scan pulse generating circuit 70a”), a second display electrode pair group side scan pulse generating circuit 70b (hereinafter simply referred to as “scan pulse generating circuit 70b”), a first display electrode pair group side scan electrode side switch circuit 75a (hereinafter simply referred to as “switch circuit 75a”), and a second display electrode pair side scan electrode side switch circuit 75b (hereinafter simply referred to as “switch circuit 75b”).

The sustain pulse generating circuit 50 includes an electric energy recovery section 51 and a voltage clamp section 55 and generates the sustain pulse voltage Vs applied to the scan electrodes SC1˜SC1080 belonging to the first display electrode pair group and/or to the scan electrodes SC1081˜SC2160 belonging to the second display electrode pair group.

The electric energy recovery section 51 includes a capacitor 51 for electric energy recovery, switching elements Q51, Q52, diodes D51, D52 for blocking reverse current, and inductors L51, L52 for resonance, and performs LC resonance between an interelectrode capacitance between electrodes of display electrode pair and the inductor L51 or the inductor L52 to form rising and falling of the sustain pulse voltage Vs. When forming the rising of the sustain pulse voltage Vs, charge accumulated in the capacitor C51 is transferred to the interelectrode capacitance via the switching element Q51, the diode D51 and the inductor L51. When forming the falling of the sustain pulse voltage Vs, the charge accumulated in the interelectrode capacitance is transferred to the capacitor C51, via the inductor L52, the diode D52 and the switching element Q52. In this way, the electric energy recovery section 51 forms rising and falling of the sustain pulse voltage Vs by the LC resonance without being supplied with electric energy from the power supply. Therefore, ideally, no electric power consumption occurs. It should be noted that the capacitor C51 has a capacitance which is sufficiently larger than the interelectrode capacitance, and is charged with about a half (Vs/2) of the sustain pulse voltage Vs to enable the capacitor C51 to serve as the electric power supply for the electric energy recovery section 51.

The voltage clamp section 55 include switching elements Q55, Q56. When the switching element Q55 is turned ON, the output voltage (voltage at node C in FIG. 6) of the sustain pulse generating circuit 50 is clamped to the sustain pulse voltage Vs. When the switching element Q56 is turned ON, the output voltage of the sustain pulse generating circuit 50 is clamped to the voltage 0(V).

As should be appreciated from the above, in the sustain pulse generating circuit 50, the sustain pulse voltage Vs is generated by controlling the switching elements Q51, Q52, Q55, and Q56. Although IGBTs are used as the switching elements Q51, Q52, Q55 and Q56 are used in the example shown in FIG. 6, MOSFETs or the like, may be used. In a case where IGBTs are used as the switching elements Q55, Q56, it is necessary to ensure a current path which is an opposite direction to a direction of a current controlled. To this end, as shown in FIG. 6, the diode D55 is connected in parallel with the switching element Q55, and the diode D56 is connected in parallel with the switching element Q56. Diodes may be connected in parallel with the switching element Q51 and the switching element Q52, respectively, to protect IGBT, although not shown in FIG. 6.

The switching element Q59 is a separation switch, which is provided to prevent a current from flowing back from the ramp waveform generating circuit 60 as described later toward the sustain pulse voltage Vs via the diode D55, when the voltage at the node C is rising to be higher than the sustain pulse voltage Vs like Vi2 in the reset period.

The ramp waveform generating circuit 60 includes two mirror integration circuits 61, 62. The mirror integration circuit 61 causes the output voltage (voltage at the node C in FIG. 6) of the ramp waveform generating circuit 60 to rise gently toward the voltage Vt. The mirror integration circuit 62 causes the output voltage of the ramp waveform generating circuit 60 to rise gently toward the voltage Vr.

The scan pulse generating circuit 70a includes an electric power source E71a of the voltage Vp, a mirror integration circuit 71a, switching elements Q71H1˜Q71H1080, and switching elements Q71L1˜Q71L1080. The mirror integration circuit 71a causes the voltage (voltage at node A in FIG. 6) at a low-voltage side of the electric power source E71a to gently fall toward the voltage Va, and clamps the voltage at a low-voltage side of the electric power source E71a to the voltage Va. The switching elements Q71L1˜Q71L1080 apply the voltage at a low-voltage side of the electric power source E71a to the associated scan electrodes, respectively, while the switching elements Q71H1˜Q71H1080 apply the voltage at a high-voltage side of the electric power source E71a to the associated scan electrodes, respectively.

The scan pulse generating circuit 70b has a similar configuration to the scan pulse generating circuit 70a and includes an electric power source E71b of the voltage Vp, a mirror integration circuit 71b, switching elements Q71H1081˜Q71H2160, and the switching elements Q71L1081˜Q71L2160. The voltage of high-voltage side of the electric power source E71b or the voltage of the low-voltage side of the electric power source E71b is applied to each of the scan electrodes SC1081˜SC2160 belonging to the second display electrode pair group.

The switch circuit 75a includes a switching element Q76a, and electrically connects or disconnects the sustain pulse generating circuit 50 and the ramp waveform generating circuit 60, to or from the scan pulse generating circuit 70a. The switch circuit 75b includes a switching element Q76b, and electrically connects or disconnects the sustain pulse generating circuit 50 and the ramp waveform generating circuit 60, to or from the scan pulse generating circuit 70a.

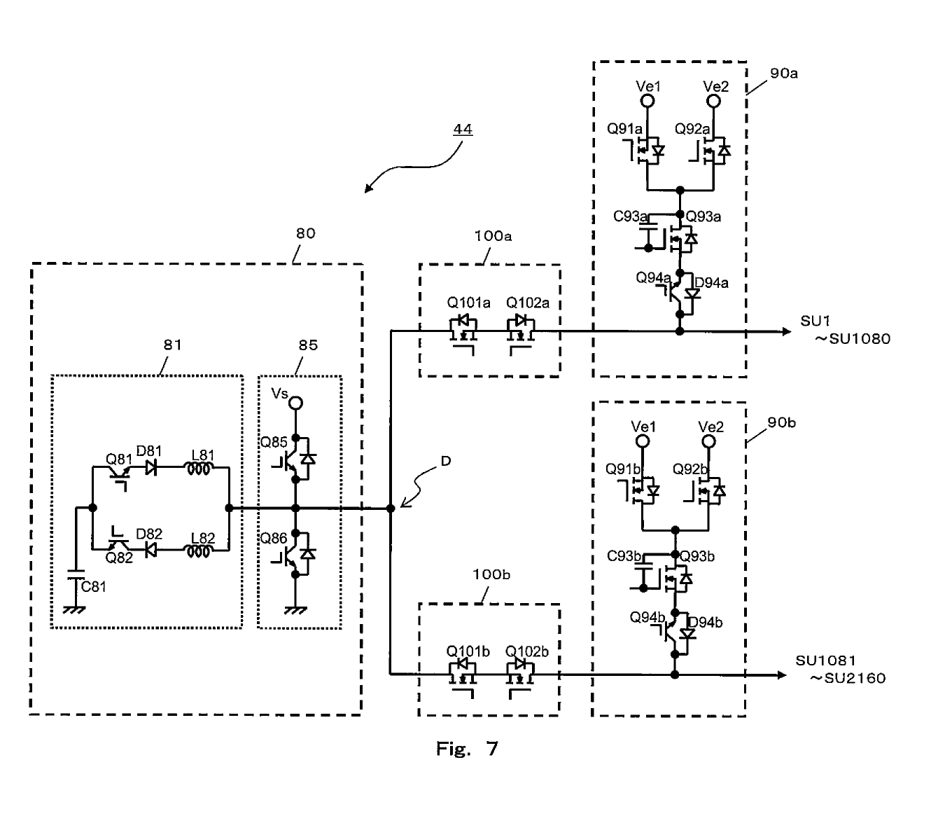

FIG. 7 is a circuit diagram of the sustain electrode driving circuit 44 of the plasma display apparatus 40 of Embodiment 1 of the present invention. The sustain electrode driving circuit 44 includes a sustain electrode side sustain pulse generating circuit 80 (hereinafter simply referred to as “sustain pulse generating circuit 80”), a first display electrode pair group side constant voltage generating circuit 90a (hereinafter simply referred to as “constant voltage generating circuit 90a”), a second display electrode pair group side constant voltage generating circuit 90b (hereinafter simply referred to as “constant voltage generating circuit 90b”), a sustain electrode side switch circuit 100a (hereinafter simply referred to as “switch circuit 100a”), and a sustain electrode side switch circuit 100b (hereinafter simply referred to as “switch circuit 100b”).

The sustain pulse generating circuit 80 includes an electric energy recovery section 81 and a voltage clamp section 85, and generates the sustain pulse voltage Vs applied to the sustain electrodes SU1˜SU1080 belonging to the first display electrode pair group and/or the sustain electrodes SU1081˜SU2160 belonging to the second display electrode pair group.

The electric energy recovery section 81 includes a capacitor 81 for electric energy recovery, switching elements Q81, Q82, diodes D81, D82 for blocking reverse current, and inductors L81, L82 for resonance, and performs LC resonance between an interelectrode capacitance between electrodes of display electrode pair and the inductor L81 or the inductor L82 to form rising and falling of the sustain pulse voltage Vs.

The voltage clamp section 85 include switching elements Q85, Q86. Like the voltage clamp section 55, the voltage clamp section 85 clamps the output voltage (voltage at node D in FIG. 7) of the sustain pulse generating circuit 80 to the sustain pulse voltage Vs or the voltage 0(V).

The constant voltage generating circuit 90a includes switching elements Q91a, Q92a, Q93a, and Q94a. The switching element Q93a and the switching element Q94a form bidirectional switches connected in series such that currents are controlled to flow in opposite directions. The constant voltage Ve1 is applied to the sustain electrodes SU1˜SU1080 belonging to the first display electrode pair group via the switching elements Q91a, Q93a and Q94a, while the constant voltage Ve2 is applied to the sustain electrodes SU1˜SU1080 belonging to the first display electrode pair group via the switching elements Q92a, Q93a and Q94a,

The constant voltage generating circuit 90b has a configuration similar to that of the constant voltage generating circuit 90a, and includes switching elements Q91b, Q92b, Q93b, and Q94b. The constant voltage generating circuit 90b applies the constant voltage Ve1 or the constant voltage Ve2 to the sustain electrodes SU1081˜SU2160 belonging to the second display electrode pair group.

The switching elements in the constant voltage generating circuits 90a, 90b are constituted by MOSFETs, IGBTs, etc, although a circuit configuration including MOSFETs and IGBTs as the switching elements in the constant voltage generating circuits 90a, 90b is shown in FIG. 7. IGBTs are used as the switching elements Q94a, Q94b. A diode D94a is connected in parallel with the switching element Q94a and a diode D94b is connected in parallel with the switching element Q94b, to ensure a current path in a direction opposite to the direction of the current to be controlled,

The switching elements Q94a is provided to flow a current from the sustain electrodes SU1˜SU1080 toward the electric power source of the voltages Ve1, Ve2. If the current is flowed only in a direction from the electric power source of the voltages Ve1, Ve2 toward the sustain electrodes SU1˜SU1080, the switching element Q94a may be omitted. The same occurs in the switching elements Q94b.

A capacitor C93a is connected to gate-drain of the switching elements Q93a, while a capacitor C93b is connected to gate-drain of the switching element Q93b. Although the capacitors C93a, C93b are provided to allow the voltages Ve1, Ve2, to gently rise during application, they may be omitted, for example, when the voltages Ve1, Ve2 are changed in step form.

The separation switch circuit 100a includes switching elements Q101a, Q102a, which form bidirectional switches connected in series such that currents are controlled to flow in opposite directions. The separation switch circuit 100a electrically connects or disconnects the sustain pulse generating circuit 80 to or from sustain electrodes SU1˜SU1080 belonging to the first display electrode pair group.

The separation switch circuit 100b includes switching elements Q101b, Q102b, which form bidirectional switches connected in series such that currents are controlled to flow in opposite directions. The separation switch circuit 100b electrically connects or disconnects the sustain pulse generating circuit 80 to or from sustain electrodes SU1081˜SU2160 belonging to the second display electrode pair group.

Subsequently, the operation of the scan electrode driving circuit 43 will be described. In Embodiment 1, description will be given assuming that the voltage Vi1 in FIG. 5 is equal to the voltage Vp, the voltage Vi2 in FIG. 5 is equal to a voltage (Vt+Vp), the voltage Vi3 in FIG. 5 is equal to the voltage Vs, the voltage Vb in FIG. 5 is equal to the voltage Vp, and the voltage Vc in FIG. 5 is equal to a voltage (Va+Vp). However, these voltages are not limited to the above but may be set suitably according to a circuit configuration.

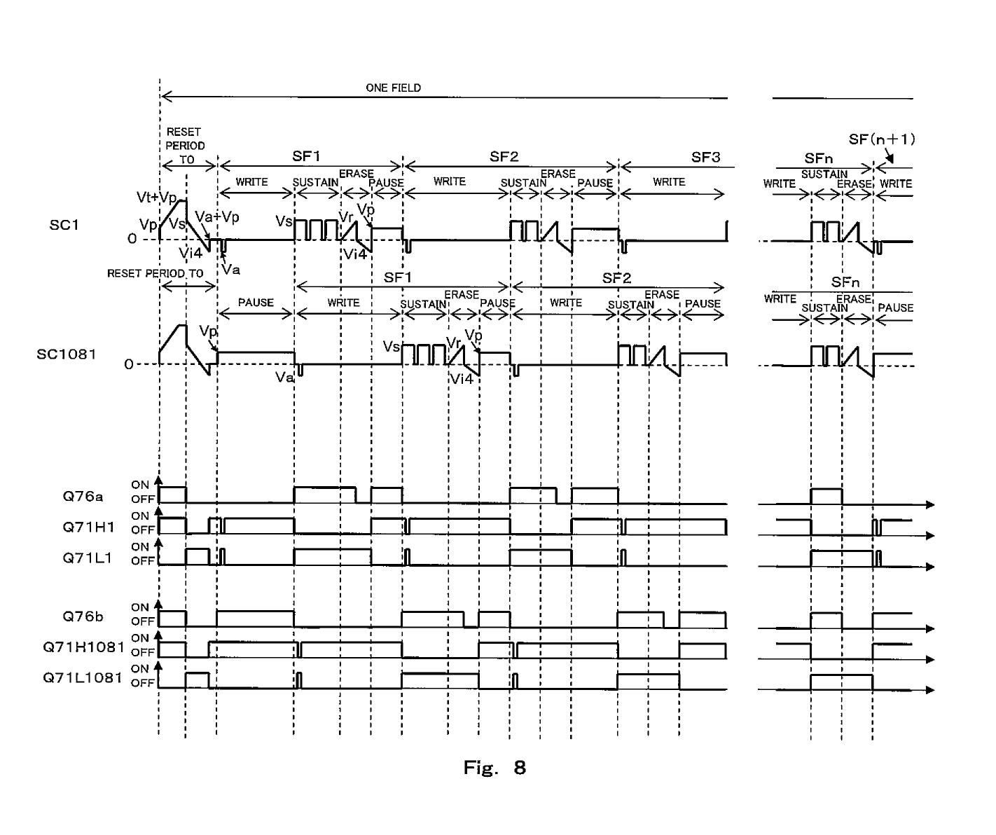

FIG. 8 is a view showing the operation of the scan electrode driving circuit 43 of the plasma display apparatus 40 according to Embodiment 1 of the present invention. FIG. 8 depicts driving voltage waveforms applied to the scan electrode SC1 belonging to the first display electrode pair group and to the scan electrode SC1081 belonging to the second display electrode pair group, and control signals for the switching elements Q71H1, Q71L1 in the scan pulse generating circuit 70a, the switching elements Q71H1081, Q71L1081 in the scan pulse generating circuit 70b, the switching element Q76a in the switch circuit 75a, and the switching element Q76b in the switch circuit 75b.

In the reset period T0, a ramp waveform voltage rising toward the voltage (Vp+Vt) is applied to the scan electrodes SC1˜SC2160. Therefore, the scan electrode driving circuit 43 turns ON the switching elements Q71H1˜Q71H2160 in the scan pulse generating circuits 70a, 70b, turns ON the switching element Q76a in the switch circuit 75a, turns ON the switching element Q76b in the switch circuit 75b, and turns ON the switching element Q56 in the sustain pulse generating circuit 50 to apply the voltage Vp to the scan electrodes SC1˜SC2160. After the switching element Q56 is turned OFF, the scan electrode driving circuit 43 operates the mirror integration circuit 61 to raise the voltage of the scan electrodes SC1˜SC2160 toward the voltage (Vp+Vt). At this time, the switching element Q59 is OFF.

Then, to apply the ramp waveform voltage falling toward the voltage Vi4 to the scan electrodes SC1˜SC2160, the scan electrode driving circuit 43 turns OFF the switching elements Q71H1˜Q71H2160 in the scan pulse generating circuits 70a, 70b, turns ON the switching elements Q71L1˜Q71L2160 in the scan pulse generating circuits 70a, 70b, and turns ON the switching elements Q55, Q59 in the sustain pulse generating circuit 50 to apply the sustain pulse voltage Vs to the scan electrodes SC1 SC2160. Then, the scan electrode driving circuit 43 turns OFF the switching element Q76a in the switch circuit 75a and the switching element Q76b in the switch circuit 75b and operates the mirror integration circuit 71a in the scan pulse generating circuit 70a and the mirror integration circuit 71b in the scan pulse generating circuit 70b. Then, at a time point when the voltage of the scan electrodes SC1˜SC2160 has decreased to the voltage Vi4, the scan electrode driving circuit 43 turns OFF switching elements Q71L1˜Q71L2160, and turns ON the switching elements Q71H1˜Q71H2160.

During the write period of the sub-field SF1 of the first display electrode pair group, to apply the scan pulse voltage to the scan electrodes SC1˜SC1080, the scan electrode driving circuit 43 turns OFF the switching element Q71H1 in the scan pulse generating circuit 70a and turns ON the switching element Q71L1 in the scan pulse generating circuit 70a to apply the voltage Va to the scan electrode SC1. Then, the scan electrode driving circuit 43 turns OFF the switching element Q71L and returns the switching element Q71H1 to ON. Then, the scan electrode driving circuit 43 turns OFF the switching element Q71H2 and turns ON the switching element Q71L2 to apply the voltage Va to the scan electrode SC2. Then, the scan electrode driving circuit 43 returns the switching element Q71L2 to OFF and returns the switching element Q71H2 to ON. Hereinafter, according to the same procedure, the voltage Va is sequentially applied to the scan electrodes SC3˜SC1080.

During the write period of the sub-field SF1 of the first display electrode pair group, the scan electrode driving circuit 43 turns OFF the switching element Q55 in the sustain pulse generating circuit 50, turns ON the switching element Q56 in the sustain pulse generating circuit 50, and turns ON the switching element Q76b in the switch circuit 75b to apply the voltage Vp to the scan electrodes SC1081˜SC2160 in the second display electrode pair group which is in the pause period.

During the sustain period of the sub-field SF1 of the first display electrode pair group, the scan electrode driving circuit 43 turns OFF the switching elements Q71H1˜Q71H1080 in the scan pulse generating circuit 70a, turns ON the switching element Q71L1˜Q71L1080 in the scan pulse generating circuit 70a, and turns ON the switching element Q76a in the switch circuit 75a, to apply the sustain pulse voltage Vs generated in the sustain pulse generating circuit 50 to the scan electrodes SC1˜SC1080 belonging to the first display electrode pair group.

To generate the sustain pulse voltage Vs in the sustain pulse generating circuit 50, the scan electrode driving circuit 43 turns OFF the switching elements Q52, Q56, and then turns ON the switching element Q51 to raise the voltage of the scan electrodes SC1˜SC1080 to a voltage near the sustain pulse voltage Vs. Then, the scan electrode driving circuit 43 turns ON the switching elements Q55 and clamps the voltage of the scan electrodes SC1˜SC1080 to the sustain pulse voltage Vs. Then, the scan electrode driving circuit 43 turns OFF the switching elements Q51, Q55, and then turns ON the switching element Q52 to decrease the voltage of the scan electrodes SC1˜SC1080 to a value near the voltage 0(V). Then, the scan electrode driving circuit 43 turns ON the switching elements Q56 and clamps the voltage of the scan electrodes SC1˜SC1080 to the voltage 0(V). The above operation repeats to generate the sustain pulse voltage Vs.

During the erase period of the sub-field SF1 for the first display electrode pair group, the scan electrode driving circuit 43 operates the mirror integration circuit 62 to apply the ramp waveform voltage rising toward the voltage Vr to the scan electrodes SC1˜SC1080. Then, the scan electrode driving circuit 43 turns OFF the switching element Q76a in the switch circuit 75a and operates the mirror integration circuit 71a to apply the ramp waveform voltage falling toward the voltage Vi4 to the scan electrodes SC1˜SC1080.

During the pause period in the sub-field SF1 of the first display electrode pair group, the scan electrode driving circuit 43 turns ON the switching element Q56 in the sustain pulse generating circuit 50, turns ON the switching element Q76a in the switch circuit 75a, and turns OFF the switching elements Q71L1˜Q71L1080 in the scan pulse generating circuit 70a and turns ON the switching elements Q71H1˜Q71H1080 in the scan pulse generating circuit 70a to apply the voltage Vp to the scan electrodes SC1˜SC1080.

During the sustain period, the erase period and the pause period in the sub-field SF1 of the first display electrode pair group, the second display electrode pair group is in the write period of SF1. To terminate the pause period, the scan electrode driving circuit 43 turns OFF the switching element Q76b in the switch circuit 75b, and then controls the corresponding switching elements of the switching elements Q71H1081˜Q71H2160 and the switching element Q71L1081˜Q71L2160 in the scan pulse generating circuit 70b to sequentially the scan pulse voltage Va to the scan electrodes SC1081˜SC2160.

During the sustain period of the sub-field SF1 of the second display electrode pair group, the scan electrode driving circuit 43 turns OFF the switching elements Q71H1081˜Q71H2160 in the scan pulse generating circuit 70b, turns ON the switching elements Q71L1081˜Q71L2160 in the scan pulse generating circuit 70b, and turns ON the switching element Q76b in the switch circuit 75b, to apply the sustain pulse voltage generated in the sustain pulse generating circuit 50 to the scan electrodes Q71L1081˜Q71L2160 belonging to the second display electrode pair group.

During the erase period in the sub-field SF1 of the second display electrode pair group, the scan electrode driving circuit 43 operates the mirror integration circuit 62 to apply a ramp waveform voltage rising toward the voltage Vr to the scan electrodes SC1081˜SC2160. Then, the scan electrode driving circuit 43 turns OFF the switching element Q76b in the switch circuit 75b, and operates the mirror integration circuit 71b to apply a ramp waveform voltage falling toward the voltage Vi4 to the scan electrodes SC1081˜SC2160.

During the pause period in the sub-field SF1 of the second display electrode pair group, the scan electrode driving circuit 43 turns ON the switching element Q56 in the sustain pulse generating circuit 50, turns ON the switching element Q76b in the switch circuit 75b, and turns OFF the switching elements Q71L1081˜Q71L2160 in the scan pulse generating circuit 70b and turns ON the switching elements Q71H1081˜Q71H2160 in the scan pulse generating circuit 70b to apply the voltage Vp to the scan electrodes SC1081˜SC2160.

The above operation repeats and the scan electrode driving circuit 43 is capable of applying the sustain pulse voltage and the erase ramp waveform voltage to the scan electrodes belonging to respective of the display electrode pair groups at different timings. Thus, by using the scan electrode driving circuit 43, the sustain period and the erase period are set at different timings between the display electrode pair groups.

With reference to FIG. 8, an operation performed when the sustain pulse voltage and the erase ramp waveform voltage are applied simultaneously to the scan electrodes belonging to all of the display electrode pair groups, in a sub-field SFn, will be described.

In the sub-field SFn, after writing to the first display electrode pair group ends, writing to the second display electrode pair group starts. Until writing to the scan electrode SC2160 ends after writing to the scan electrode SC1080 ends, ON/OFF states of the switching element Q76a in the switch circuit 75a, the switching elements Q71H1˜Q71H1080 in the scan pulse generating circuit 70a, and the switching elements Q71L1˜Q71L1080 in the scan pulse generating circuit 70a, are maintained. On the other hand, the second display electrode pair group transitions from the pause period to the write period. Therefore, the switching element Q76b in the switch circuit 75b is changed from ON to OFF, and then the corresponding switching elements of the switching elements Q71H1081˜Q71H2160 and the switching element Q71L1081˜Q71L2160 in the scan pulse generating circuit 70b are controlled to sequentially apply the scan pulse voltage Va to the scan electrodes SC1081˜SC2160.

After the scan pulse voltage Va is applied to the scan electrode SC2160, a sustain period during which the sustain pulse voltage Vs is applied to the first display electrode pair group and the second display electrode pair group simultaneously starts. The scan electrode driving circuit 43 turns ON the switching element Q76a in the switch circuit 75a and the switching element Q76b in the switch circuit 75b, turns OFF the switching elements Q71H1˜Q71H1080 in the scan pulse generating circuit 70a, turns ON the switching elements Q71L1˜Q71L1080 in the scan pulse generating circuit 70a, turns OFF the switching elements Q71H1081˜Q71H2160 in the scan pulse generating circuit 70b, and turns ON the switching elements Q71L1081˜Q71L2160 in the scan pulse generating circuit 70b. Thereafter, the sustain pulse voltage Vs generated in the sustain pulse generating circuit 50 is applied to the scan electrodes SC1˜SC1080 belonging to the first display electrode pair group and to the scan electrodes SC1081˜SC2160 belonging to the second display electrode pair group.

During the erase period in the sub-field SFn, the scan electrode driving circuit 43 operates the mirror integration circuit 62 to apply the ramp waveform voltage rising toward the voltage Vr to the scan electrodes SC1˜SC2160. Then, the scan electrode driving circuit 43 turns OFF the switching elements Q76a and Q76b in the switch circuits 75a and 75b, respectively, operates the mirror integration circuits 71a and 71b to apply the ramp waveform voltage falling toward the voltage Vi4 to the scan electrodes SC1˜SC2160. At this stage, the ON/OFF states of respective switching elements are the same as those at a time point when the reset period ends. For this reason, the operation in a next sub-field SF (n+1) is similar to a write operation of the first display electrode pair group in the sub-field SF1 and a pause operation of the second display electrode pair group in the sub-field SF1. Thus, by using the scan electrode driving circuit 43, the sustain pulse voltage and the erase ramp waveform can be applied to all of the display electrode pair groups simultaneously.

Thus, the scan electrode driving circuit 43 of Embodiment 1 includes the single sustain pulse generating circuit 50 for generating the sustain pulse voltage Vs applied to the scan electrodes belonging to an arbitrary display electrode pair group, the scan pulse generating circuits 70a, 70b each of which is used for generating the scan pulse voltage Va applied to the scan electrodes belonging to the first display electrode pair group or the second display electrode pair group, and switch circuits 75a, 75b each of which is used for electrically connecting or disconnecting the scan pulse generating circuit 70a, 70b to or from the sustain pulse generating circuit 50. Since the sustain pulse voltage Vs generated in the sustain pulse generating circuit 50 is applied to the scan electrodes belonging to each display electrode pair group, it is possible to implement a plasma display apparatus in which a luminance difference is less likely to be generated in the vicinity of a display region which is a boundary between the first display electrode pair group and the second display electrode pair group, with a simple configuration.

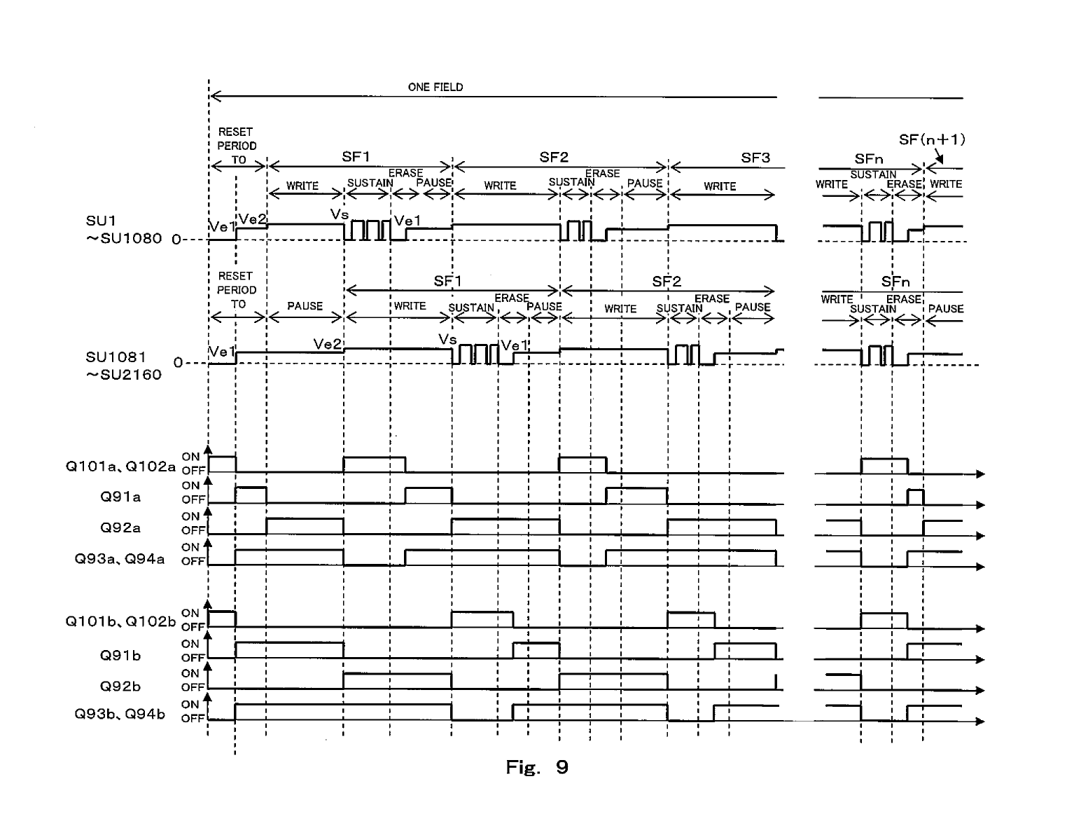

FIG. 9 is a view showing an operation of the sustain electrode driving circuit 44 in the plasma display apparatus 40 of Embodiment 1. FIG. 9 depicts driving voltage waveforms applied to the sustain electrodes SU1˜SU1080 belonging to the first display electrode pair group and to the sustain electrodes SU1081˜SU2160 belonging to the second display electrode pair group, and control signals for the switching elements Q91a˜Q94a in the constant voltage generating circuit 90a, control signals for the switching elements Q91b˜Q94b in the constant voltage generating circuit 90b, control signals for the switching elements Q101a, Q102a in the switch circuit 100a, and control signals for the switching elements Q101b, Q102b in the switch circuit 100b.

During the reset period, to apply the voltage 0(V) to the sustain electrodes SU1˜SU2160, the sustain electrode driving circuit 44 turns ON the switching element Q86 in the sustain pulse generating circuit 80. Then, the sustain electrode driving circuit 44 turns ON the switching elements Q101a, Q102a in the switch circuit 100a and electrically grounds the sustain electrodes SU1˜SU1080 belonging to the first display electrode pair group, and turns ON the switching elements Q101b, Q102b in the switch circuit 100b and electrically grounds the sustain electrodes SU1081˜SU2160 belonging to the second display electrode pair group.

Then, to apply the voltage Ve1 to the sustain electrodes SU1˜SU2160, the sustain electrode driving circuit 44 turns OFF the switching elements Q101a, Q102a, Q101b, Q102b in the switch circuits 100a, 100b. Then, the sustain electrode driving circuit 44 turns ON the switching elements Q91a, Q93a, and Q94a in the constant voltage generating circuit 90a, and turns ON the switching elements Q91b, Q93b, and Q94b in the constant voltage generating circuit 90b.

During the write period in the sub-field SF1 of the first display electrode pair group, to apply the voltage Ve2 to the sustain electrodes SU1˜SU1080, the sustain electrode driving circuit 44 turns OFF the switching element Q91a in the constant voltage generating circuit 90a and turns ON the switching element Q92a in the constant voltage generating circuit 90a.

During the sustain period in the sub-field SF1 of the first display electrode pair group, the sustain electrode driving circuit 44 turns OFF the switching elements Q93a, Q94a in the constant voltage generating circuit 90a and turns ON the switching elements Q101a, 102a in the separation switch circuit 100a, to apply the sustain pulse voltage Vs generated in the sustain pulse generating circuit 80 to the sustain electrodes SU1˜SU1080.

Then, to apply the voltage 0(V) to the sustain electrodes SU1˜SU1080, the sustain electrode driving circuit 44 turns OFF the switching element Q85 and turns ON the switching element Q86. Further, to apply the voltage Ve1 to the sustain electrodes SU1˜SU1080, the sustain electrode driving circuit 44 turns OFF the switching elements Q101a, Q102a in the switch circuit 100a. Then, the sustain electrode driving circuit 44 turns ON the switching elements Q91a, Q93a, Q94a in the constant voltage generating circuit 90a and turns OFF the switching element Q92a in the constant voltage generating circuit 90a.

During the sustain period of the sub-field SF1 of the first display electrode pair group, the second display electrode pair group is in the write period of the sub-field SF1. Therefore, the sustain electrode driving circuit 44 turns OFF the switching element Q91b in the constant voltage generating circuit 90b and turns ON the switching element Q92b in the constant voltage generating circuit 90b, to apply the voltage Ve2 to the sustain electrodes SU1081˜SU2160 belonging to the second display electrode pair group.

During the following sustain period in the sub-field SF1 of the second display electrode pair group, the sustain electrode driving circuit 44 turns OFF the switching elements Q93b, Q94b in the constant voltage generating circuit 90b, and turns ON the switching elements Q101b, Q102b in the switch circuit 100b, to apply the sustain pulse voltage Vs generated in the sustain pulse generating circuit 80 to the sustain electrodes SU1081 to SU2160.

Then, to apply the voltage 0(V) to the sustain electrodes SU1081˜SU2160, the sustain electrode driving circuit 44 turns OFF the switching element Q85 and turns ON the switching element Q86. Further, to apply the voltage Ve1 to the sustain electrodes SU1081˜SU2160, the sustain electrode driving circuit 44 turns OFF the switching elements Q101b, Q102b in the switch circuit 100b. Then, the sustain electrode driving circuit 44 turns ON the switching elements Q91b, Q93b, Q94b in the constant voltage generating circuit 90b and turns OFF the switching element Q92b in the constant voltage generating circuit 90b.

The above operation repeats and the sustain electrode driving circuit 44 is capable of applying the sustain pulse voltage and the erase waveform voltage to the sustain electrodes belonging to respective of the display electrode pair groups at different timings. Thus, by using the sustain electrode driving circuit 44, the sustain period and the erase period are set at different timings between the display electrode pair groups.

With reference to FIG. 9, an operation performed when the sustain pulse voltage and the erase waveform voltage are applied all at once to respective of the sustain electrodes belonging to all of the display electrode pair groups in the sub-field SFn will be described.

In the sub-field SFn, after writing to the first display electrode pair group ends, the following writing to the second display electrode pair group starts. Until writing to the scan electrode SC2160 in the second electrode display pair group ends after writing to the scan electrode SC1080 in the first display electrode pair group ends, the sustain electrode driving circuit 44 maintains the ON/OFF states of the switching elements Q91a˜Q94a in the constant voltage generating circuit 90a, and the switching elements Q101a, Q102a in the switch circuit 100a. On the other hand, the second display electrode pair group transitions from the pause period to the write period. Therefore, the sustain electrode driving circuit 44 turns OFF the switching element Q91b in the constant voltage generating circuit 90b and turns ON the switching element Q92b in the constant voltage generating circuit 90b.

After the scan pulse voltage Va is applied to the scan electrode SC2160, a sustain period during which the sustain pulse voltage Vs is applied to the first display electrode pair group and to the second display electrode pair group simultaneously starts. The sustain electrode driving circuit 44 turns OFF the switching elements Q91a˜Q94a and the switching elements Q91b˜Q94b in the constant voltage generating circuits 90a, 90b. Then, the sustain electrode driving circuit 44 turns ON the switching elements 101a, 102a, and the switching elements Q101b, 102b in the switch circuits 100a, 100b. Then, the sustain pulse voltage Vs generated in the sustain pulse generating circuit 80 is applied to the sustain electrodes SU1˜SU1080 belonging to the first display electrode pair group and to the sustain electrodes SU1081˜SU2160 belonging to the second display electrode pair group.

During the erase period in the sub-field SFn, the sustain electrode driving circuit 44 turns OFF the switching element Q85 and turns ON the switching element Q86 to apply the voltage 0(V) to the sustain electrodes SU1˜SU2160. Then, the sustain electrode driving circuit 44 turns OFF the switching elements Q101a, Q102a, Q101b, Q102b in the switch circuits 100a and 100b, to apply the voltage Ve1 to the sustain electrodes SU1˜SU2160. And, the sustain electrode driving circuit 44 turns ON the switching elements Q91a, Q93a, Q94a, Q91b, Q93b, Q94b in the constant voltage generating circuits 90a, 90b, and turns OFF the switching elements Q92a, Q92b in the constant voltage generating circuits 90a, 90b. At this stage, the ON/OFF states of respective switching elements are the same as those at a time point when the reset period T0 ends. For this reason, the operation in a next sub-field SF (n+1) following the sub-field SFn is similar to a write operation of the first display electrode pair group in the sub-field SF1 and a pause operation of the second display electrode pair group in the sub-field SF1. Thus, by using the sustain electrode driving circuit 44, the sustain pulse voltage and the erase waveform can be applied to all of the display electrode pair groups all at once.

Thus, the sustain electrode driving circuit 44 of Embodiment 1 includes the single sustain pulse generating circuit 80 for generating the sustain pulse voltage Vs applied to the sustain electrodes belonging to an arbitrary display electrode pair group, the constant voltage generating circuits 90a, 90b for generating a constant voltage applied to the sustain electrodes belonging to the first display electrode pair group or the second display electrode pair group, and the switch circuits 100a, 100b for electrically connecting or disconnecting the sustain electrodes belonging to the first display electrode pair group or the second display electrode pair group to or from the sustain pulse generating circuit 80. Since the sustain pulse voltage Vs generated in the sustain pulse generating circuit 80 is applied to the sustain electrodes belonging to each display electrode pair group all at once, it is possible to implement the sustain electrode driving circuit 44 which allows a luminance difference to be generated less easily in the vicinity of a display region which is a boundary between the first display electrode pair group and the second display electrode pair group, with a simple configuration.

The circuit configurations of the sustain pulse generating circuit 80, the ramp waveform generating circuit 60, etc, in Embodiment 1 are merely exemplary, and other circuit configuration may be used to generate similar driving voltage waveforms.

For example, the electric energy recovery section 51 shown in FIG. 6 transfers charge on the capacitor C51 to the interelectrode capacitance via the switching element Q51, the diode D51, the inductor L51 and the switching element Q59, when forming the rising of the sustain pulse voltage, while the electric energy recovery section 51 returns the charge in the interelectrode capacitance to the capacitor C51 via the inductor L52, the diode D52 and the switching element Q52 when forming the falling of the sustain pulse voltage. Alternatively, connection of one terminal of the inductor L51 may be changed from the source of the switching element Q59 to the node C so that the charge on the capacitor C51 may be transferred to the interelectrode capacitance via the switching element Q51, the diode D51 and the inductor L51 when forming the rising of the sustain pulse voltage. In a further alternative, a circuit configuration in which one inductor serves as the inductor L51 and the inductor L52 may be used.

In a further alternative, a circuit configuration in which one inductor may serve as the inductors L81, L82 in the electric energy recovery section 81 in the sustain electrode driving circuit 44 shown in FIG. 7 may be used.

Although the ramp waveform generating circuit 60 shown in FIG. 6 has a circuit configuration including the two mirror integration circuits 61, 62, a circuit configuration including one voltage switch circuit and one mirror integration circuit may be used.

Further, a circuit configuration may be used, in which the capacitor C51 in the electric energy recovery section 51 shown in FIG. 6 is omitted, the overall electric energy recovery section 51 shown in FIG. 7 may be omitted, and the node D in FIG. 7 may be connected to a connecting point of the switching element Q51 and the switching element Q52 in FIG. 6.

A circuit configuration may be used, in which the overall electric energy recovery section 51 shown in FIG. 6 is omitted, the capacitor C81 in the electric energy recovery section 81 shown in FIG. 7 may be omitted, and the node C is connected to a connecting point of the switching element Q81 and the switching element Q82 in FIG. 8.

[Selecting Method of Driving Mode of Plasma Display Panel]

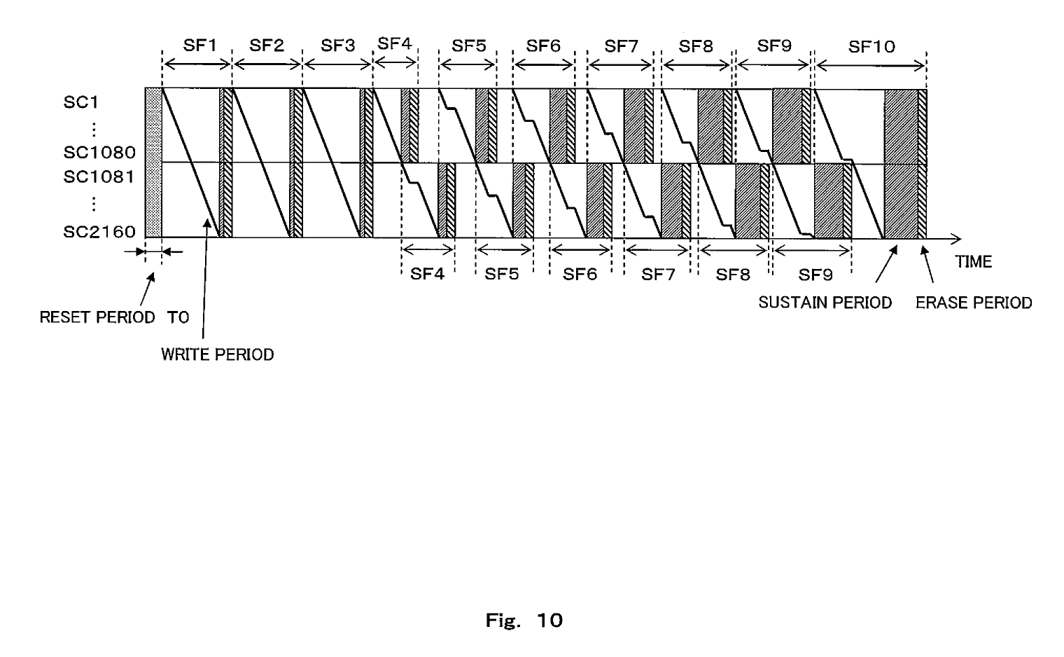

FIG. 10 is a view showing a selecting method of a driving mode of the plasma display panel 10 according to Embodiment 1 of the present invention. Vertical axis indicates the scan electrodes SC1˜SC2160, and horizontal axis indicates time. The wall voltage adjusting period consists of the erase period. Timings when the write operation is performed are indicated by solid lines, the sustain periods are hatched by oblique lines from right and upper to left and lower, and the erase periods are hatched by oblique lines from left and upper to right and lower. A time period in which the solid line is horizontal in the write period is a time period in which the write operation stops for a moment. A time period when the write operation of a certain display electrode pair group stops for a moment is a timing in the erase period in which at least one of the remaining display electrode pair groups is in the erase period.

First of all, for each of sub-fields SF1˜SF9, which is obtained by excluding a last sub-field SF10, from one field, either a first driving mode for setting the sustain period and the erase period for each display electrode pair group, or a second driving mode in which sustain discharge and erase discharge for one display electrode pair group occur concurrently with sustain discharge and erase discharge for another display electrode pair group, is selected.

Specifically, comparison is made between a sustain period and an erase period in a certain sub-field. If the sustain period is longer than the erase period (sustain period>erase period), an overall driving time can be reduced, by selecting the first driving mode for setting the sustain period and the erase period for each of the first display electrode pair group and the second display electrode pair group, independently, in this sub-field.

As shown in FIG. 4, during a period when erase discharge is performed for one display electrode pair group, it is necessary to inhibit the write operation from occurring for the other display electrode pair group. Therefore, by setting the first driving mode for performing the sustain discharge and the erase discharge independently for each of the display electrode pair groups, if the sustain period is longer than the erase period, a write operation in a next sub-field can occur earlier by a time difference “sustain period—erase period.” Therefore, an overall driving time can be reduced.

On the other hand, if the erase period is longer than the sustain period (sustain period<erase period), an overall driving time can be reduced by selecting, for a sub-field, the second driving mode for setting the sustain period and the erase period such that the sustain period and the erase period of the first display electrode pair group are synchronized with the sustain period and the erase period of the second display electrode pair group.

When the driving mode is selected as described above in the example of FIG. 10, the second driving mode for setting the sustain period and the erase period such that the sustain period and the erase period of one display electrode pair group are synchronized with the sustain period and the erase period of another display electrode pair group, is selected for the sub-fields SF1˜SF3 in which the erase period is longer than the sustain period. In contrast, in the sub-fields SF4˜SF9, the sustain period is longer than the erase period, and therefore, the first driving mode for setting the sustain period and the erase period independently for each display electrode pair group is selected.

The driving mode setting section 46 compares the length of the sustain period to the length of the erase period for each of sub-fields other than a sub-field with a maximum luminance weight, based on luminance weight of each of sub-fields other than the sub-field with a maximum luminance weight, and selects the first driving mode for setting the sustain period and the erase period for each display electrode pair group or the second driving mode for setting the sustain period and the erase period such that the sustain period and the erase period of one display electrode pair group are synchronized with the sustain period and the erase period of another display electrode pair group. The timing generating circuit 45 outputs timing signals based on the first driving mode or the second driving mode selected by the driving mode setting section 46, to the driving circuits 41˜44.

The sub-field SF10 is a sub-field having a longest sustain period (in other words, with largest luminance weight) in one field. For the sub-field with the largest luminance weight, the second driving mode for setting the sustain period and the erase period such that the sustain period and the erase period of one display electrode pair group are synchronized with the sustain period and the erase period of another display electrode pair group is always set with priority, over selecting of the first driving mode or the second driving mode based on a result of comparison between the length of the sustain period and the length of the erase period.

The driving mode setting section 46 shown in FIG. 5 sets the second driving mode in the sub-field with the largest luminance weight. The image signal processing circuit 41 decides the luminance weight of each sub-field in one field based on an image signal. The driving mode setting section 46 specifies the sub-field with largest luminance weight in one field, based on the luminance weight decided by the image signal processing circuit 41. Further, for the specified sub-field with the largest luminance weight, the driving mode setting section 46 sets the second driving mode for setting the sustain period and the erase period such that the sustain period and the erase period of one display electrode pair group are synchronized with the sustain period and the erase period of another display electrode pair group. The timing generating circuit 45 outputs timing signals based on the second driving mode set by the driving mode setting section 46, to the driving circuits 41˜44.

As a result, during the sustain period of the sub-field SF10, the entire of the display image of the plasma display panel 10 is driven based on the sustain pulse voltage Vs generated in the sustain pulse generating circuit 50 in the scan electrode driving circuit 43 and the sustain pulse voltage Vs generated in the sustain pulse generating circuit 80 in the sustain electrode driving circuit 44. As compared to a case where the sustain pulse generating circuits 50, 80 are provided for each display electrode pair group, or a case where a single sustain pulse generating circuit is provided as the sustain pulse generating circuits 50, 80, for the display electrode pair groups, the voltage applied to the discharge cells of the plasma display panel 10 is made uniform. This results in a lighting state in which a luminance difference is less likely to be generated in the vicinity of a display region at a boundary between the first display electrode pair group and the second display electrode pair group.

Further, for the sub-field with a largest luminance weight, sustain discharge is performed based on the second driving mode such that a luminance difference is less likely to be generated in the vicinity of a display region at a boundary between plural display electrode pair groups. For this reason, in sub-fields other than the sub-field with a largest luminance weight, even if sustain discharge is performed for each display electrode pair group in the first driving mode, luminance weight is small in the other sub-fields. Therefore, a viewer is less likely to recognize a luminance difference in the vicinity of a display region at a boundary between the first display electrode pair group and the second display electrode pair group.

Therefore, a sufficient sub-field number can be ensured in the high-definition plasma display panel 10. In addition, it is possible to provide a driving method of the plasma display panel 10 in which a luminance difference is less likely to be generated in the vicinity of a display region at a boundary between plural display electrode pair groups.

### Embodiment 2

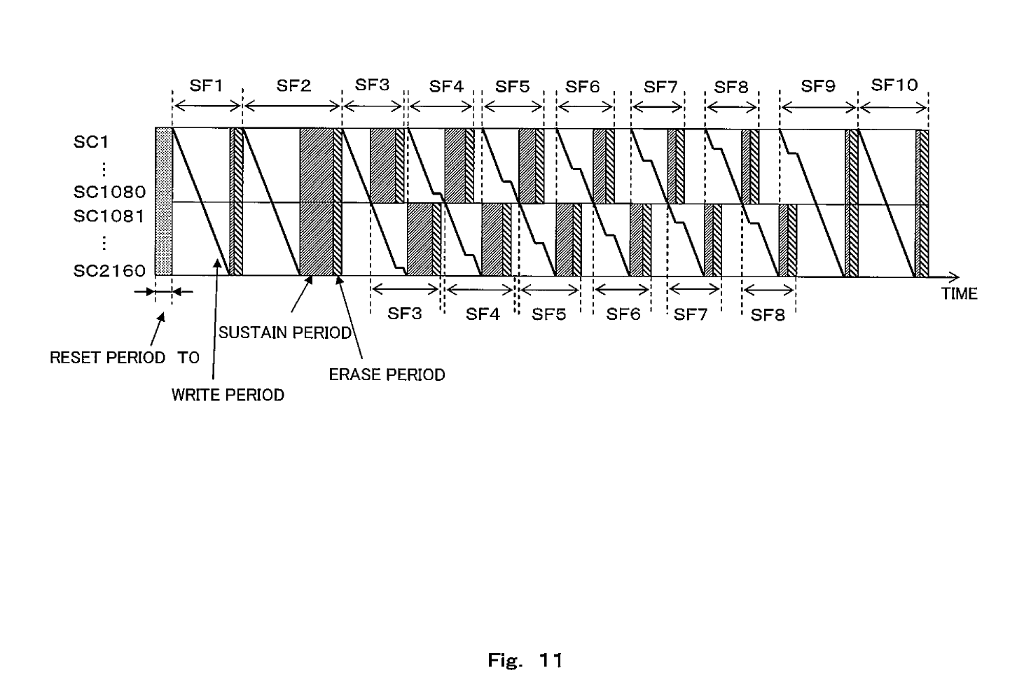

FIG. 11 is a view showing a sub-field configuration applied to a driving method of the plasma display panel 10 of Embodiment 2. As in the example shown in FIG. 10, vertical axis indicates scan electrodes SC1˜SC2160 and horizontal axis time. The wall voltage adjusting period consists of the erase period. Timings when the write operation is performed are indicated by solid lines, the sustain periods are hatched by oblique lines from right and upper to left and lower, and the erase periods are hatched by oblique lines from left and upper and right and lower. A plasma display apparatus of Embodiment 2 is similar to that of Embodiment 1 shown in FIG. 5 and will not be described repetitively

The configuration of the sub-fields of Embodiment 2 is different from the sub-field configuration of Embodiment 1 shown in FIG. 10 in that sustain periods which are luminance weights are arranged in decreasing order of length, except for the sub-field SF1. For the sub-field SF2 with a largest luminance weight, the second driving mode for setting the sustain period and the erase period such that the sustain period and the erase period for one display electrode pair group are synchronized with the sustain period and the erase period for another display electrode pair groups, in all of display electrode pair groups, is set. For the sub-fields SF1, SF9, SF10 in which the erase period is longer than the sustain period, the second driving mode for setting the sustain period and the erase period such that the sustain period and the erase period for one display electrode pair group are synchronized with the sustain period and the erase period for another display electrode pair groups, is set. For the sub-fields SF3 SF8 in which the sustain period is longer than the erase period, the first driving mode for setting the sustain period and the erase period for each of the display electrode pair groups, is set.

The sub-field SF10 is the last sub-field in one field, and therefore, in a state where one display electrode pair group is in the sustain period, a write operation cannot be performed for the other display electrode pair group. From this fact, the driving time can be reduced by always setting the second driving mode for the sub-field SF10. By arranging the sustain periods in decreasing order of length in plural sub-fields, the luminance weight is smallest in the sub-field SF10 and the second driving mode is easily set for the sub-field SF10. Furthermore, the overall driving time can be reduced without fluctuating a center of limit emission between the sub-fields.

It is desired that the sub-field SF1 be set as a sub-field with a smallest luminance weight. The reason is as follows.

After reset discharge is performed for all of discharge cells, address discharge during the write period is intense. Therefore, a discharge crosstalk is easily generated between discharge cells. If the discharge crosstalk is generated, a write failure arises, and discharge cells for which non-lighting is selected might emit light inadvertently during the sustain period. Hence, a display quality of the plasma display panel 10 would be degraded.

To solve this, the sub-field SF1 just after the reset period T0 is the sub-field with a smallest luminance weight and lighting is caused to occur without fail in the sub-field SF1 when lighting occurs in the sub-field SF2 and the following sub-fields. Thereby, a discharge cross-talk between the discharge cells is suppressed while minimizing reduction of expressed state of low luminance gray scale, and hence a display quality of the plasma display panel 10 is improved.

Therefore, the sub-field configuration shown in FIG. 11 can reduce the overall driving time as compared to the sub-field configuration shown in FIG. 10. These sub-field configurations are formed based on the timing signals output from the timing generating circuit 45 to the driving circuits 41˜44.

Like Embodiment 1, lighting may occur without fail in the sub-field SF1 in the same manner. This prevents a discharge crosstalk from occurring and further improves a display quality of the plasma display panel 10.

### Embodiment 3

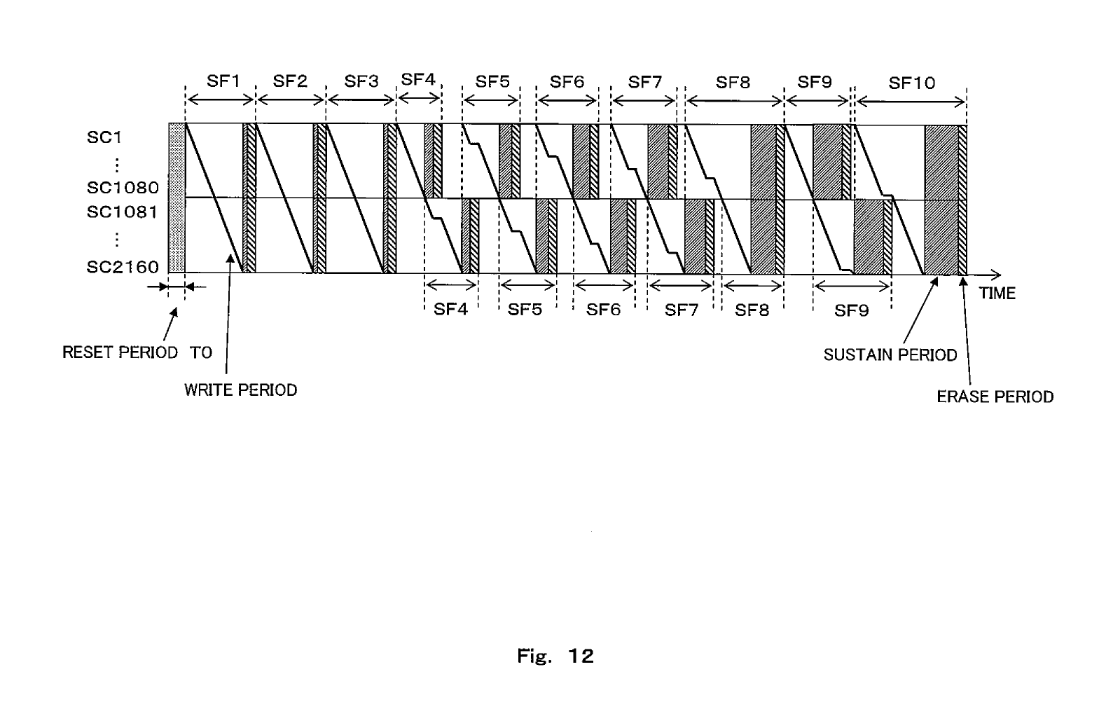

FIG. 12 is a view showing a sub-field configuration applied to a driving method of the plasma display panel 10 of Embodiment 3. As in the example shown in FIG. 10, vertical axis indicates scan electrodes SC1˜SC2160 and horizontal axis time. The wall voltage adjusting period consists of the erase period. Timings when the write operation is performed are indicated by solid lines, the sustain periods are hatched by oblique lines from right and upper to left and lower, and the erase periods are hatched by oblique lines from left and upper and right and lower. A plasma display apparatus of Embodiment 3 is similar to that of Embodiment 1 and will not be described repetitively.

FIG. 12 shows a sub-field configuration in which a sub-field with a highest lighting ratio is a sub-field SF8. The sub-field with a highest lighting ratio in one field includes discharge cells performing sustain discharge, which are largest in number. Therefore, by performing the sustain discharge and the erase discharge simultaneously in all of the display electrode pair groups, it is possible to provide a display state in which a luminance difference is less likely to be generated in the vicinity of a display region at a boundary between the display electrode pair groups.

The driving mode setting section 46 show in FIG. 5 selects a sub-field with a highest lighting ratio. The image signal processing circuit 41 decides discharge cells to which writing is performed in each sub-field. The driving mode setting section 46 finds the number of discharge cells which perform sustain discharge for each sub-field based on lighting ratio information output from the image signal processing circuit 41 and specifies the sub-field including discharge cells largest in number as the sub-field with the highest lighting ratio. The timing generating circuit 45 outputs timing signals to the driving circuits 41˜44 based on result specified by the driving mode setting section 46. In this way, the second driving mode for setting the sustain period and the erase period such that the sustain period and the erase period of one display electrode pair group are synchronized with the sustain period and the erase period of another display electrode pair groups in all display electrode pair groups, is always set, for the sub-field with the highest lighting ratio. Thus, it is possible to provide a driving method of the plasma display panel 10 in which a luminance difference is less likely to be generated in the vicinity of a display region which is a boundary between display electrode pair groups.

As described in Embodiment 2, if the sub-field SF1 is caused to perform lighting without fail to reduce a discharge crosstalk, a sub-field with a highest lighting ratio may be specified, except for the sub-field SF1.

### Embodiment 4

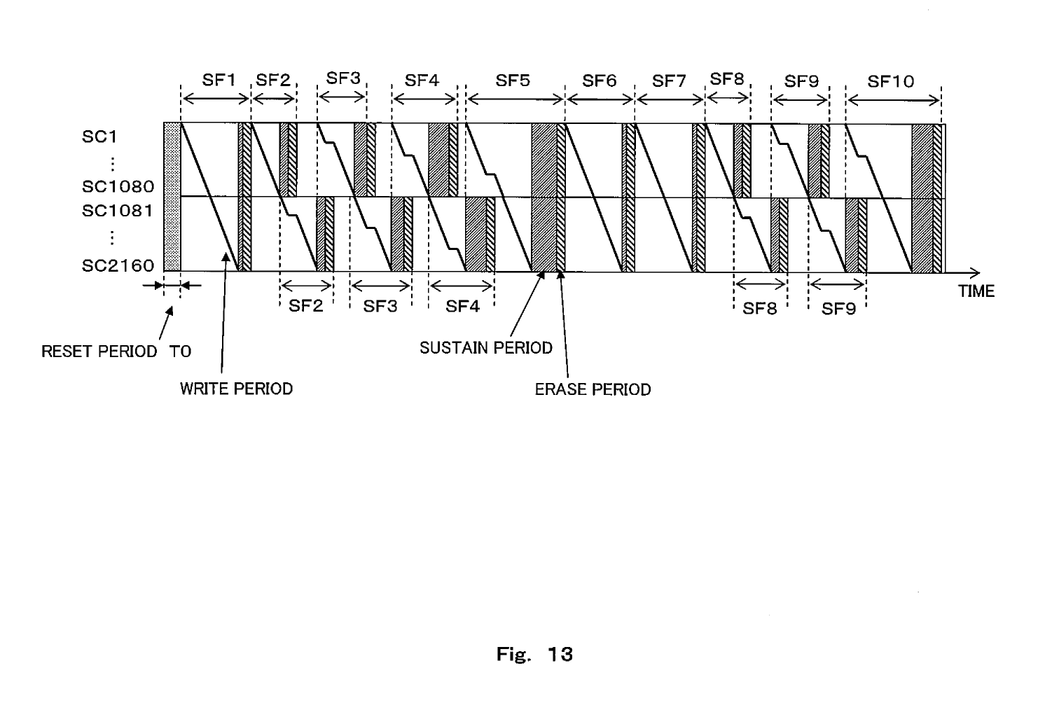

FIG. 13 is a view showing a sub-field configuration applied to a driving method of the plasma display panel 10 of Embodiment 4. As in the example shown in FIG. 10, vertical axis indicates scan electrodes SC1˜SC2160 and horizontal axis time. The wall voltage adjusting period consists of the erase period. Timings when the write operation is performed are indicated by solid lines, the sustain periods are hatched by oblique lines from right and upper to left and lower, and the erase periods are hatched by oblique lines from left and upper and right and lower. A plasma display apparatus of Embodiment 4 of the present invention is similar to that of Embodiment 1 and will not be described repetitively

In NTSC (national Television System Committee) adopted in our country, a time of one field is about 16.7 ms, but in PAL (Phase Alternating Line) which is a main stream in European countries, a time of one field is about 20 ms. Since a cycle of one field is longer in PAL than in NTSC, a flicker is sometimes observed if weighing of luminance for plural sub-fields included in one field increases or decreases once, which leads to a degraded display quality of a plasma display panel.

Accordingly, in PAL, weighing of luminance for plural sub-fields included in one field increases or decreases twice. For example, in the sub-field configuration shown in FIG. 13, sub-fields SF1˜SF5 are arranged in increasing order of length in a first stage and then sub-fields SF6˜SF10 are arranged in increasing order of length in a second stage. As a result, occurrence of a flicker in the plasma display panel 10 is prevented and its display quality is improved.

In the sub-field configuration shown in FIG. 13, it is supposed that the sub-field SF5 is a sub-field with a highest luminance weight and the sub-field SF10 is a sub-field with a second highest luminance weight. In this case, for the sub-fields SF5, SF10, the second driving mode for setting the sustain period and the erase period such that the sustain period and the erase period of one display electrode pair group are synchronized with the sustain period and the erase period of another display electrode pair groups, in all of the display electrode pair groups, is desirably always set.

The sub-field SF1 which is a sub-field just after the end of the reset period T0 and the sub-field SF6 which is a sub-field just after the sub-field SF5 with a largest luminance weight, a discharge crosstalk is easily generated between discharge cells. Therefore, lighting desirably occurs in these sub-fields without fail. Also, since there are many discharge cells which perform sustain discharge in the sub-fields SF1, SF6, the second driving mode for setting the sustain period and the erase period such that the sustain period and the erase period of one display electrode pair group are synchronized with the sustain period and the erase period of another display electrode pair groups, is desirably always set.

The above setting is performed by the timing generating circuit 45 including the driving mode setting section 46. Thus, in PAL in which time of one field is relatively longer, a display state in which a luminance difference is less likely to be generated is implemented.

Specific sub-field configurations in FIGS. 10˜FIG. 13 described in Embodiment 1˜4 are merely exemplary. A driving method for improving each display image may be combined, or a driving method for reducing a driving time may be combined. For example, even in NTSC, sustain discharge may be caused to occur simultaneously, in the sub-field with a largest luminance weight and a sub-field with a second largest luminance weight, in plural display electrode pair groups.

Specific numeric values used in Embodiment 1 to Embodiment 4 are merely exemplary, but may be set to values according to a property of the plasma display panel 10, a specification of the plasma display apparatus, etc.

Numerous modifications and alternative embodiments of the present invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention. Industrial Applicability

A driving method of a plasma display panel and a plasma display apparatus of the present invention can ensure a sufficient sub-field number for ensuring an image quality and suppress occurrence of a luminance difference in the vicinity of a display region at a boundary between display electrode pair groups, even in a super-high-definition plasma display panel, and are useful in driving of the high-definition plasma display panel. Reference Citation Lists

10 plasma display panel

22 scan electrode

23 sustain electrode

24 display electrode pair

32 data electrode

40 plasma display apparatus

41 image signal processing circuit

42 data electrode driving circuit

43 scan electrode driving circuit

44 sustain electrode driving circuit

45 timing generating circuit

46 driving mode setting section

50, 80 sustain pulse generating circuit

51, 81 electric energy recovery section

55, 85 voltage clamp section

60 ramp waveform generating circuit

70a, 70b scan pulse generating circuit

75a, 75b switch circuit

90a, 90b constant voltage generating circuit

100a, 100b switch circuit

1. A method of driving a plasma display panel including plural display electrode pairs each including a scan electrode and a sustain electrode, and plural data electrodes, and having a structure in which discharge cells are respectively formed at locations where the display electrode pairs cross the data electrodes, respectively, in which
each field constituting an image includes plural sub-fields;
each of the sub-fields includes a write period during which the discharge cells generate write discharge, a sustain period during which the discharge cells which generated write discharge generate sustain discharge, and a wall voltage adjusting period during which wall voltage of the discharge cells which generated the sustain discharge is adjusted for next write discharge, the method comprising:
comparing the sustain period to the wall voltage adjusting period, in each of the sub-fields;
selecting a first driving mode in which the plural display electrode pairs are divided into plural display electrode pair groups, the sustain period and the wall voltage adjusting period are set for each of the display electrode pair groups, and in a period in which one display electrode pair group is in the wall voltage adjusting period, and successive write operation in display electrode pair groups other than the one display electrode pair group is restricted, if the sustain period is longer than the wall voltage adjusting period;
selecting a second driving mode in which the sustain period and the wall voltage adjusting period are performed for all of the display electrode pairs in the plasma display panel, if the sustain period is shorter than the wall voltage adjusting period; wherein
the second driving mode is set for at least one of the plural sub-fields based on length information of the sustain period in each of the sub-fields, which is performed with priority over selecting of the first driving mode or the second driving mode.

2. (canceled)

3. The method of driving the plasma display panel, according to claim 1, wherein the second driving mode is set for a sub-field with a longest sustain period, among the plural sub-fields.

4. The method of driving the plasma display panel, according to claim 3, wherein
the second driving mode is set for a sub-field with a second longest sustain period, among the plural sub-fields.

5. The method of driving the plasma display panel, according to claim 1, wherein
the second driving mode is set for at least one of the plural sub-fields based on number information of discharge cells which generate sustain discharge in each of the sub-fields, which is performed with priority over selecting of the first driving mode or the second driving mode.

6. The method of driving the plasma display panel, according to claim 5, wherein
the second driving mode is set for a sub-field in which the number of discharge cells which generate sustain discharge is largest, among the plural sub-fields.

7. The method of driving the plasma display panel, according to claim 6, wherein
the second driving mode is set for a sub-field in which the number of discharge cells which generate sustain discharge during the sustain period is second largest, among the plural sub-fields.

8. (canceled)

9. A plasma display apparatus comprising:
a plasma display panel including plural display electrode pairs each including a scan electrode and a sustain electrode, and plural data electrodes, and having a structure in which discharge cells are respectively formed at locations where the display electrode pairs cross the data electrodes, respectively; and
a driving circuit for driving the plasma display panel;
each field constituting an image includes plural sub-fields;
each of the sub-fields includes a write period during which the discharge cells generate write discharge, a sustain period during which the discharge cells which generated the write discharge generate sustain discharge, and a wall voltage adjusting period during which wall voltage of the discharge cells which generated the sustain discharge is adjusted for next write discharge;
the driving circuit compares the sustain period to the wall voltage adjusting period, in each of the sub-fields,
selects a first driving mode in which the plural display electrode pairs are divided into plural display electrode pair groups, the sustain period and the wall voltage adjusting period are set for each of the display electrode pair groups, and in a period in which one display electrode pair group is in the wall voltage adjusting period, and successive write operation in display electrode pair groups other than the one display electrode pair group is restricted, if the sustain period is longer than the wall voltage adjusting period; [[or]]
selects a second driving mode in which the sustain period and the wall voltage adjusting period are performed for all of the display electrode pairs in the plasma display panel, if the sustain period is shorter than the wall voltage adjusting period; and
the second driving mode is set for at least one of the plural sub-fields based on length information of the sustain period in each of the sub-fields, which is performed with priority over selecting of the first driving mode or the second driving mode.

10. (canceled)

11. The plasma display apparatus, according to claim 9, wherein
the second driving mode is set for a sub-field with a longest sustain period, among the plural sub-fields.

12. The plasma display apparatus, according to claim 11, wherein
the second driving mode is set for a sub-field with a second longest sustain period, among the plural sub-fields.

13. The plasma display apparatus, according to claim 9, wherein
the second driving mode is set for at least one of the plural sub-fields based on number information of discharge cells which generate sustain discharge in each of the sub-fields, which is performed with priority over selecting of the first driving mode or the second driving mode.

14. The plasma display apparatus, according to claim 13, wherein
the second driving mode is set for a sub-field in which the number of discharge cells which generate sustain discharge is largest, among the plural sub-fields.

15. The plasma display apparatus, according to claim 14, wherein
the second driving mode is set for a sub-field in which the number of discharge cells which generate sustain discharge during the sustain period is second largest, among the plural sub-fields.

16. (canceled)

17. (canceled)
